(19) United States
(12) Patent Application Publication
(10) Pub. No.: US 2016/0311710 A1
(43) Pub. Date: Oct. 27, 2016

(54) PROCESSES FOR TREATMENT OF METAL-CONTAINING FLUIDS, RELATED APPARATUS, AND RELATED COMPOSITIONS

(71) Applicant: HEARTLAND TECHNOLOGY PARTNERS LLC, St. Louis, MO (US)

(72) Inventors: Bernard F. Duesel, JR., Goshen, NY (US); Benjamin N. Laurent, Cottage Grove, WI (US); Craig Clerkin, Stoughton, WI (US)

(21) Appl. No.: 15/139,509

(22) Filed: Apr. 27, 2016

Related U.S. Application Data
(60) Provisional application No. 62/153,317, filed on Apr. 27, 2015.

(51) Int. Cl. C02F 1/70; C02F 1/10; C02F 1/66; C02F 1/04

(52) U.S. Cl. CPC C02F 1/70; C02F 1/048; C02F 1/10; C02F 1/66; C02F 2101/106

(57) ABSTRACT

The disclosure relates generally to liquid concentrators, and more specifically to compact, portable, cost-effective wastewater concentrators that can be easily connected to and use sources of waste heat. The concentrators can be used to concentrate liquid wastewater streams including waste metals such as selenium. The liquid wastewater and heated gas for concentration of the same can be obtained from an air quality control system (AQCS) process for cleaning/discharging of flue gas from an electrical power generation unit (EGU). Resulting cementitious solid waste products formed from the concentrated liquid wastewater provide a stable solid matrix that limits, reduces, or prevents leaching of metals such as selenium from the solid waste products into the environment.

### FIELD OF THE DISCLOSURE

This application relates generally to liquid concentrators, and more specifically to cost-effective wastewater concentrators that can be easily connected to and use sources of waste heat, whether in a smaller scale, compact, and/or portable setting, in a larger scale, fixed installation, or otherwise. The concentrators can be used to concentrate liquid wastewater streams, for example those including waste metals such as selenium. The liquid wastewater and heated gas for concentration of the same can be obtained from an air quality control system (AQCS) process for cleaning/discharging of flue gas from an electrical power generation unit (EGU).

### BACKGROUND

Concentration of volatile or other substances can be an effective form of treatment or pretreatment for a broad variety of wastewater streams and may be carried out within various types of commercial processing systems. At high levels of concentration, many wastewater streams may be reduced to residual material in the form of slurries containing high levels of dissolved and suspended solids. Such concentrated residual may be readily solidified by conventional techniques for disposal within landfills or, as applicable, delivered to downstream processes for further treatment prior to final disposal. Concentrating wastewater can greatly reduce freight costs and required storage capacity and may be beneficial in downstream processes where materials are recovered from the wastewater.

An important measure of the effectiveness of a wastewater concentration process is the volume of residual produced in proportion to the volume of wastewater entering the process. In particular, low ratios of residual volume to feed volume (high levels of concentration) are the most desirable. Where the wastewater contains dissolved and/or suspended non-volatile matter, the volume reduction that may be achieved in a particular concentration process that relies on evaporation of volatiles is, to a great extent, limited by the method chosen to transfer heat to the process fluid.

Conventional processes that affect concentration by evaporation of water and other volatile substances may be classified as direct or indirect heat transfer systems depending upon the method employed to transfer heat to the liquid undergoing concentration (the process fluid). Indirect heat transfer devices generally include jacketed vessels that contain the process fluid, or tubular, plate, bayonet, or coil type heat exchangers that are immersed within the process fluid. Mediums such as steam or hot oil are passed through the jackets or heat exchangers in order to transfer the heat required for evaporation. Direct heat transfer devices implement processes where the heating medium is brought into direct contact with the process fluid, which occurs in, for example, submerged combustion gas systems.

As part of air pollution controls, power plants routinely contain an air quality control system (AQCS) process to manage power plant exhaust, which AQCS process includes wet flue gas desulfurization (FGD) systems to control sulfur dioxide emissions. Due to their modes of operation, wet FGD systems also capture trace elements and compounds (e.g., volatile, non-volatile, or otherwise) also present in the coal flue gas stream, such as selenium (Se), mercury (Hg), arsenic (As), and others. As part of normal operation, FGD systems require purging of their circulating scrubber water to maintain optimal chemical concentrations (e.g., chlorides). These resulting FGD purge water (or wastewater) streams, which can vary in volume from as little as 0.5 GPM, 5 GPM, 30 GPM, or 50 GPM up to 100 GPM, 500 GPM, or higher (e.g., 30 GPM to 100 GPM in many cases), are facing increasingly stringent environmental regulations and discharge limitations. Specific to selenium, proposed regulations include effluent discharge limits of 10 μg/L (i.e., 10 parts per billion [ppb], 0.01 parts per million [ppm], or 0.01 mg/L). However, an FGD purge water stream may contain dissolved selenium concentrations ranging from less than 10 ppb to several thousand ppb and thus may require some wastewater treatment to reduce concentrations to discharge limitations. Conventional stabilization methods are often able to retain arsenic and mercury to levels below TCLP thresholds. However, selenium has been more troublesome, particularly in concentrated brines.

### SUMMARY

In one aspect, the disclosure relates to a process for concentrating wastewater comprising selenium with a heated gas, the process comprising: (a) combining the heated gas and a liquid flow of the wastewater at a pressure to form a mixture thereof at a first location upstream of a narrowed portion of a mixing corridor; and (b) drawing the mixture through the mixing corridor and reducing the static pressure of the mixture in the narrowed portion to mix gas and liquid phases of the mixture, thus heating and vaporizing a portion of the liquid in the mixture to yield a partially vaporized mixture comprising (i) a concentrated liquid wastewater comprising the selenium from the liquid wastewater, and (ii) a cooled gas comprising vaporized liquid from the liquid wastewater.

In another aspect, the disclosure relates to a process for concentrating wastewater comprising selenium with a heated gas comprising sulfur dioxide (SO₂), the process comprising: (a) combining the heated gas and a liquid flow of the wastewater to form a mixture thereof; (b) absorbing at least a portion of the sulfur dioxide from the heated gas into the liquid of the mixture; and (c) directly transferring heat from the heated gas to the liquid of the mixture and chemically reducing the oxidation state of the selenium in the liquid wastewater, thus heating and vaporizing a portion of the liquid in the mixture to yield a partially vaporized mixture comprising (i) a concentrated liquid wastewater comprising selenium from the liquid wastewater and in a more chemically reduced form relative to the selenium in the liquid wastewater, and (ii) a cooled gas comprising vaporized liquid from the liquid wastewater. In some refinements, the liquid wastewater comprises flue gas desulfurization (FGD) purge water from a flue gas desulfurization (FGD) process and/or the heated gas comprises a side stream withdrawn from a flue gas air quality control system (AQCS) process.

In another aspect, the disclosure relates to a process for concentrating wastewater comprising selenium with a heated gas, the process comprising: (a) combining the heated gas and a liquid flow of the wastewater to form a mixture thereof; and (b) directly transferring heat from the heated gas to the liquid of the mixture and chemically reducing the oxidation state of the selenium in the liquid wastewater with a reducing agent, thus heating and vaporizing a portion of the liquid in the mixture to yield a partially vaporized mixture comprising (i) a concentrated liquid wastewater comprising selenium from the liquid wastewater and in a more chemically reduced form relative to the selenium in the liquid wastewater, and (ii) a cooled gas comprising vaporized liquid from the liquid wastewater. In some refinements, the liquid wastewater comprises flue gas desulfurization (FGD) purge water from a flue gas desulfurization (FGD) process and/or the heated gas comprises a side stream withdrawn from a flue gas air quality control system (AQCS) process.

In another aspect, the disclosure relates to a process for concentrating wastewater comprising flue gas desulfurization (FGD) purge water and selenium with a heated gas comprising a side stream withdrawn from a flue gas air quality control system (AQCS) process, the process comprising: (a) combining the heated gas and a liquid flow of the wastewater to form a mixture thereof; and (b) directly transferring heat from the heated gas to the liquid of the mixture and chemically reducing the oxidation state of the selenium in the liquid wastewater with a reducing agent, thus heating and vaporizing a portion of the liquid in the mixture to yield a partially vaporized mixture comprising (i) a concentrated liquid wastewater comprising selenium from the liquid wastewater and in a more chemically reduced form relative to the selenium in the liquid wastewater, and (ii) a cooled gas comprising vaporized liquid from the liquid wastewater.

In another aspect, the disclosure relates to a process for concentrating wastewater (e.g., with or without selenium and/or other waste metals) with a heated gas fly ash (FA), the process comprising: (a) combining the heated gas and a liquid flow of the wastewater to form a mixture thereof (e.g., in a concentrator apparatus as disclosed herein or otherwise); (b) removing at least a portion of the fly ash from the heated gas into the liquid of the mixture; and (c) directly transferring heat from the heated gas to the liquid of the mixture, thus heating and vaporizing a portion of the liquid in the mixture to yield a partially vaporized mixture comprising (i) a concentrated liquid wastewater comprising fly ash from the liquid wastewater, and (ii) a cooled gas comprising vaporized liquid from the heated gas. In a refinement, at least 80% (e.g., at least 80%, 90%, 95%, 98% or 99% and/or up to 90%, 95%, 99%, or 99.5%) of the fly ash in the heated gas is removed from the heated gas and recovered in the concentrated liquid wastewater. In another refinement, less than 20% (e.g., less than 20%, 10%, 5%, 2%, 1% or 0.5%) of the fly ash in the heated gas is not removed from the heated gas and is present in the cooled gas (e.g., for exhaust or return to another unit operation). In another refinement, the liquid wastewater comprises one or more metals selected from the group consisting of arsenic (As), barium (Ba), cadmium (Cd), chromium (Cr), lead (Pb), mercury (Hg), selenium (Se) (e.g., in Se(VI), Se(IV), and/or Se(0) oxidation states), and silver (Ag). In another refinement, the liquid wastewater comprises flue gas desulfurization (FGD) purge water from a flue gas desulfurization (FGD) process. In another refinement, the heated gas comprises a side stream withdrawn from a flue gas air quality control system (AQCS) process (e.g., 0.01 vol. % to 50 vol. % of the main process stream from which it is drawn; alternatively up to 100 vol. % of the main process stream from which it is drawn). For example, the side stream can be withdrawn from an AQCS process stream subsequent to one or more unit operations selected from the group consisting of selective catalytic reduction, air preheating, and particulate removal. For example, the cooled gas can be fed as a return stream to the AQCS process (e.g., by feeding the return stream to an AQCS process stream prior to one or more unit operations selected from the group consisting of electrostatic precipitation and flue gas desulfurization (FGD)).

Various embodiments and refinements of the foregoing processes and related compositions are possible. In a refinement, the liquid wastewater comprises flue gas desulfurization (FGD) purge water from a flue gas desulfurization (FGD) process. In another refinement, the liquid wastewater has a total selenium concentration ranging from 10 ppb to 10000 ppb. In another refinement, the liquid wastewater further comprises one or more metals selected from the group consisting of arsenic (As), barium (Ba), cadmium (Cd), chromium (Cr), lead (Pb), mercury (Hg), and silver (Ag). In another refinement, the heated gas comprises a selenium reducing agent. In another refinement, the cooled gas further comprises entrained liquid droplets comprising selenium; and the process further comprises removing at least a portion of the liquid droplets to form a demisted cooled gas.

In another refinement, the selenium in the liquid wastewater is present in one or more oxidation states selected from the group consisting of Se(IV) and Se(VI). In a further refinement, the selenium in the liquid wastewater is present in at least the Se(VI) oxidation state, and Se(VI) is present in at least 50 wt. % relative to total selenium in the liquid wastewater. In a further refinement, the selenium in the liquid wastewater is present in at least the Se(IV) oxidation state, and Se(IV) is present in at least 50 wt. % relative to total selenium in the liquid wastewater. In a further refinement, the selenium in the liquid wastewater is present in both the Se(IV) and Se(VI) oxidation states, and Se(IV) and Se(VI) in combination are present in at least 50 wt. % relative to total selenium in the liquid wastewater. In a further refinement, the selenium in the liquid wastewater further is present in the Se(0) oxidation state and in an amount up to 50 wt. % relative to total selenium in the liquid wastewater.

In another refinement, the process comprises combining and vaporizing the mixture under conditions to reduce the oxidation state of the selenium in the liquid wastewater, thereby providing the selenium in the concentrated liquid wastewater in a more reduced form relative to the selenium in the liquid wastewater. In a further refinement, the molar average oxidation state of the selenium in the concentrated liquid wastewater ranges from 0 to 4.5 units. In a further refinement, the molar average oxidation state of the selenium in the concentrated liquid wastewater is lower than the molar average oxidation state of the selenium in the liquid wastewater by 1 to 6 units. In a further refinement, the concentrated liquid wastewater is substantially free from selenium species having an oxidation state greater than 4. In a further refinement, the concentrated liquid wastewater is substantially free from selenium species having a negative oxidation state. In a further refinement, the reducing conditions are selected from the group consisting of an acidic pH value and a reducing oxidation-reduction potential (ORP) value.

In another refinement, the heated gas comprises sulfur dioxide (SO₂). In a further refinement, the cooled gas comprises sulfur dioxide at a lower level relative to the heated gas. In a further refinement, the heated gas further comprises fly ash (FA). In a further refinement, the heated gas is substantially free from fly ash (FA).

In another refinement, the heated gas comprises a side stream withdrawn from a flue gas air quality control system (AQCS) process. In a further refinement, the side stream represents 0.01 vol. % to 50 vol. % of the main AQCS process stream from which it is withdrawn. In a further refinement, the process comprises withdrawing the side stream from an AQCS process stream subsequent to one or more unit operations selected from the group consisting of selective catalytic reduction, air preheating, and particulate removal. In a further refinement, the process comprises feeding the cooled gas as a return stream to the AQCS process, for example feeding the return stream to an AQCS process stream prior to one or more unit operations selected from the group consisting of electrostatic precipitation and flue gas desulfurization (FGD). In a further refinement, the liquid wastewater comprises flue gas desulfurization (FGD) purge water from the AQCS process. In a further refinement, the heated gas further comprises a heated gas stream from other than an AQCS process.

In another refinement, the process further comprises combining a pH-adjusting agent with the mixture of the heated gas and the liquid wastewater. In a further refinement, the pH-adjusting agent comprises an alkaline agent, for example where the heated gas also comprises sulfur dioxide (SO₂).

In another aspect, the disclosure relates to a process for forming a concentrated waste stream comprising selenium from a concentrated liquid wastewater formed according to any of the foregoing processes (e.g., the concentrated liquid wastewater further comprising total solids ranging from 30 wt. % to 80 wt. %), the process comprising feeding the concentrated liquid wastewater to a solid/liquid separator unit operation, thereby forming (i) a concentrated waste stream comprising selenium and total solids ranging from 30 wt. % to 90 wt. % and having a total solids concentration higher than that of the concentrated liquid wastewater, and (ii) a dilute liquid waste stream comprising selenium. In a refinement, the solid/liquid separator unit operation comprises a settling tank. In another refinement, the process further comprises recycling and combining the dilute liquid waste stream with the mixture of the heated gas and the liquid wastewater.

In another aspect, the disclosure relates to a process for forming a cementitious solid waste product comprising selenium, the process comprising combining the concentrated waste stream according to any of its disclosed embodiments with one or more cement-forming additives to form a solidification/stabilization (S/S) mixture; and curing the S/S mixture to form a cementitious solid waste product comprising selenium.

In another aspect, the disclosure relates to a process for forming a cementitious solid waste product, the process comprising: (a) providing a concentrated waste stream comprising water, selenium, and total solids, wherein: (i) the molar average oxidation state of the selenium in the concentrated waste stream ranges from 0 to 4.5 units, and (ii) the total solids are present in the concentrated waste stream in an amount ranging from 30 wt. % to 90 wt. %; (b) combining the concentrated waste stream with one or more cement-forming additives to form a solidification/stabilization (S/S) mixture; and (c) curing the S/S mixture to form a cementitious solid waste product comprising selenium. In a refinement, the selenium in the concentrated waste stream is present in one or more oxidation states selected from the group consisting of Se(0) and Se(IV). In another refinement, the concentrated waste stream is substantially free from selenium species having an oxidation state greater than 4. In another refinement, the concentrated waste stream is substantially free from selenium species having a negative oxidation state. The concentrated waste stream further comprises fly ash (e.g., separate from that which could be added as a cement-forming additive in part (b)). In another refinement, the concentrated waste stream further comprises a reaction product of sulfur dioxide (SO₂) and water (e.g., a sulfite or other reducing agent formed upon absorption of sulfur dioxide, such as from a flue gas AQCS process).

In another aspect, the disclosure relates to a cementitious solid waste product comprising: a cured solidification/stabilization (S/S) mixture comprising (i) a concentrated waste stream comprising selenium and (ii) one or more cement-forming additives. In a refinement, the solid waste product is formed by the process of any of the foregoing embodiments for forming the concentrated waste stream.

Various embodiments and refinements of the foregoing cementitious solid waste products and related processes are possible. In a refinement, the cementitious solid waste as analyzed by a toxicity characteristic leaching procedure (TCLP) has a selenium concentration in the TCLP leachate of less than 1000 ppb, for example where the TCLP selenium concentration in the TCLP leachate is less than 70% of the total selenium concentration in the cementitious solid waste. In another refinement, the S/S mixture has (i) a concentration of the concentrated waste stream ranging from 50 wt. % to 90 wt. %, and (ii) a concentration of cement-forming additives ranging from 10 wt. % to 50 wt. %. In another refinement, the cement-forming additives comprise one or more of cement, fly ash, lime, and iron sulfate heptahydrate. In another refinement, the cement-forming additives comprise cement in the S/S mixture in a concentration ranging from 2 wt. % to 20 wt. %. In another refinement, the cement-forming additives comprise fly ash in the S/S mixture in a concentration ranging from 5 wt. % to 30 wt. %.

### BRIEF DESCRIPTION OF THE DRAWINGS

FIG. 1 is a general schematic diagram of a liquid concentrator.

FIG. 2 is a perspective view of a liquid concentrator.

FIG. 3 is a front perspective view of an evaporator/concentrator portion of the liquid concentrator of FIG. 2.

FIG. 4 is a schematic diagram of a control system which may be used in the liquid concentrator of FIG. 2 to control the operation of the various component parts of the liquid concentrator.

FIG. 5 is a schematic diagram of a process for concentrating and disposing solid material in a wastewater stream.

FIG. 6 is a schematic diagram of a process for concentrating and disposing solid material in a flue gas desulfurization (FGD) wastewater stream.

FIG. 7 is an alternative schematic diagram of a process for concentrating and disposing solid material in a flue gas desulfurization (FGD) wastewater stream.

FIG. 8 is a representative selenium Pourbaix diagram showing selenium form as a function of ORP value (E, measured in volts relative to a standard hydrogen electrode (SHE)) and pH value.

FIG. 9 is a graph illustrating TCLP metal leachate concentrations for representative metals, including selenium, in terms of the metal concentration in the TCLP leachate.

FIG. 10 is a graph illustrating TCLP metal leachate concentrations for representative metals, including selenium, in terms of the relative fractional amount of metal leached from the cementitious solid waste into the TCLP leachate (determined from total metal concentration in the cementitious solid waste and expressed on a consistent basis with the TCLP leachate).

### DETAILED DESCRIPTION

The liquid concentrator described herein may be used to concentrate a wide variety of wastewater streams, such as waste water from industry, runoff water from natural disasters (floods, hurricanes), refinery caustic, leachate such as landfill leachate (e.g., from power plants), flowback water from completion of natural gas wells, produced water from operation of natural gas wells, flue gas desulfurization (FGD) water from power plants (e.g., from an air quality control system (AQCS) process for power plant flue gas or other sulfur dioxide-containing gas), etc. The liquid concentrator is practical, energy efficient, reliable, and cost-effective. The liquid concentrator described herein has all of these desirable characteristics and provides significant advantages over conventional wastewater concentrators, especially when the goal is to manage a broad variety of wastewater streams.

Moreover, the concentrator may be largely fabricated from highly corrosion resistant, yet low cost materials such as fiberglass and/or other engineered plastics. This is due, in part, to the fact that the disclosed concentrator is designed to operate under minimal differential pressure. For example, a differential pressure generally in the range of only 10 to 30 inches water column is required. Also, because the gas-liquid contact zones of the concentration processes generate high turbulence within narrowed (compact) passages at or directly after the venturi section of the flow path, the overall design is very compact as compared to conventional concentrators where the gas liquid contact occurs in large process vessels. As a result, the amount of high alloy metals required for the concentrator is quite minimal. Also, because these high alloy parts are small and can be readily replaced in a short period of time with minimal labor, fabrication costs may be cut to an even higher degree by designing some or all of these parts to be wear items manufactured from lesser quality alloys that are to be replaced at periodic intervals. If desired, these lesser quality alloys (e.g., carbon steel) may be coated with corrosion and/or erosion resistant liners, such as engineered plastics including elastomeric polymers, to extend the useful life of such components. Likewise, pumps may be provided with corrosion and/or erosion resistant liners to extend the life of the pumps, thus further reducing maintenance and replacement costs.

The liquid concentrator provides direct contact of the liquid to be concentrated and the hot gas, effecting highly turbulent heat exchange and mass transfer between hot gas and the liquid, e.g., wastewater, undergoing concentration. Moreover, the concentrator employs highly compact gas-liquid contact zones, making it minimal in size as compared to known concentrators. The direct contact heat exchange feature promotes high energy efficiency and eliminates the need for solid surface heat exchangers as used in conventional, indirect heat transfer concentrators. Further, the compact gas-liquid contact zone eliminates the bulky process vessels used in both conventional indirect and direct heat exchange concentrators. These features allow the concentrator to be manufactured using comparatively low cost fabrication techniques and with reduced weight as compared to conventional concentrators. Both of these factors favor portability and cost-effectiveness. Thus, the liquid concentrator is more compact and lighter in weight than conventional concentrators, which make it ideal for use as a portable unit. Additionally, the liquid concentrator is less prone to fouling and blockages due to the direct contact heat exchange operation and the lack of solid heat exchanger surfaces. The liquid concentrator can also process liquids with significant amounts of suspended solids because of the direct contact heat exchange. As a result, high levels of concentration of the process fluids may be achieved without need for frequent cleaning of the concentrator.

More specifically, in liquid concentrators that employ indirect heat transfer, the heat exchangers are prone to fouling and are subject to accelerated effects of corrosion at the normal operating temperatures of the hot heat transfer medium that is circulated within them (steam or other hot fluid). Each of these factors places significant limits on the durability and/or costs of building conventional indirectly heated concentrators, and on how long they may be operated before it is necessary to shut down and clean or repair the heat exchangers. By eliminating the bulky process vessels, the weight of the liquid concentrators and both the initial costs and the replacement costs for high alloy components are greatly reduced. Moreover, due to the temperature difference between the gas and liquid, the relatively small volume of liquid contained within the system, the relatively large interfacial area between the liquid and the gas, and the reduced relative humidity of the gas prior to mixing with the liquid, the concentrator approaches the adiabatic saturation temperature for the particular gas/liquid mixture, which is typically in the range of about 140 degrees Fahrenheit to about 190 degrees Fahrenheit. This mild operating temperature beyond the evaporation zone is a factor that allows favorable use of low-cost yet highly corrosion-resistant engineered materials of construction throughout the remaining process zones of the concentrator (i.e., which reduces capital costs compared to other wastewater concentrators). The concentrator can be classified as a “low momentum” concentrator, which refers to the high rate at which discharge fluid from the concentrator is recirculated back to the inlet of the evaporation zone, which is typically in the range of 10:1 to 15:1 times the feed rate of wastewater into the concentrator. Multiple passes of the liquid phase adds stability to the process by maintaining a high ratio of wastewater undergoing concentration to hot inlet gas volume within the concentrator. This feature prevents drying of small liquid droplets (e.g., at the low end of a droplet particle size distribution characterizing the droplet population in the concentrator) created in the highly turbulent evaporation zone by maintaining a high ratio of liquid to inlet hot gas volume, which causes rapid saturation of the gas phase at close to the adiabatic saturation temperature for the continuous gas phase and discontinuous liquid phase mixture. This approach to thermodynamic equilibrium effectively quenches the driving force for the gaseous stream to absorb additional water and thus prevents complete drying of wastewater droplets which would lead to troublesome buildup of solids upon wetted walls of the processing equipment causing need for frequent and often arduous cleaning cycles. Thus, rather than precisely balancing the injected wastewater feed at the precise level of total solids present in the wastewater at a given point in time, the high recirculation allows the process to self-adjust to variances in the feed wastewater composition without causing process disturbances. Further, this feature stabilizes the concentration process whenever there is need to precisely add reagents to the feed wastewater (e.g., controlling pH, to prevent foaming or sequestering components within the concentrated phase).

Moreover, the concentrator is designed to operate under negative pressure, a feature that greatly enhances the ability to use a very broad range of fuel or waste heat sources as an energy source to affect evaporation. In fact, due to the draft nature of these systems, pressurized or non-pressurized burners may be used to heat and supply the gas used in the concentrator. Further, the simplicity and reliability of the concentrator is enhanced by the minimal number of moving parts and wear parts that are required. In general, only two pumps and a single induced draft fan are required for the concentrator when it is configured to operate on waste heat such as stack gases from engines (e.g., generators or vehicle engines), turbines, industrial process stacks, gas compressor systems, and exhaust stacks, such as landfill gas exhaust stacks, flue gas exhaust stacks, or otherwise. These features provide significant advantages that reflect favorably on the versatility and the costs of buying, operating and maintaining the concentrator.

The concentrator may be run in a transient start up condition, or in a steady state condition. During the startup condition, the demister sump is first filled with wastewater feed. As the level of wastewater feed approaches the normal operating level of the sump, a re-circulating circuit is then established between a lower inlet of the evaporation zone and the outlet of the sump. Once recirculation has been established, wastewater feed to an upper inlet to the evaporation zone is established. Once both recirculating and wastewater feed flows to the lower and upper inlets of the evaporation zone have been established, flow of hot gas to the system is established. During initial processing, the combined fresh wastewater introduced into the upper wastewater inlet and recirculated wastewater introduced to the lower recirculated inlet is at least partially evaporated in a narrowed portion of a concentrator section and is deposited in the demister sump in a more concentrated form than the fresh wastewater. Over time, the wastewater in the demister sump and the re-circulating circuit approaches a desired level of concentration. At this point, the concentrator may be run in a continuous mode where the amount of total solids drawn off from an extraction port equals the amount of total solids introduced in fresh wastewater through the inlet. The balance of total solids generally includes the contribution from total dissolved solids and total suspended solids, for example where the fresh wastewater feed might contain mostly or only dissolved solids, and the concentrated stream drawn from the extraction port might contain a higher fraction of suspended solids having precipitated from dissolved solids during the concentration process. Likewise, the amount of water evaporated within the concentrator is replaced by an equal amount of water in the fresh wastewater. Thus, conditions within the concentrator approach the adiabatic saturation point of the mixture of heated gas and wastewater and continuous operation at a desired equilibrium rate of water removal is established while evaporated water vapor exits the concentrator on the discharge side of the induced draft fan.

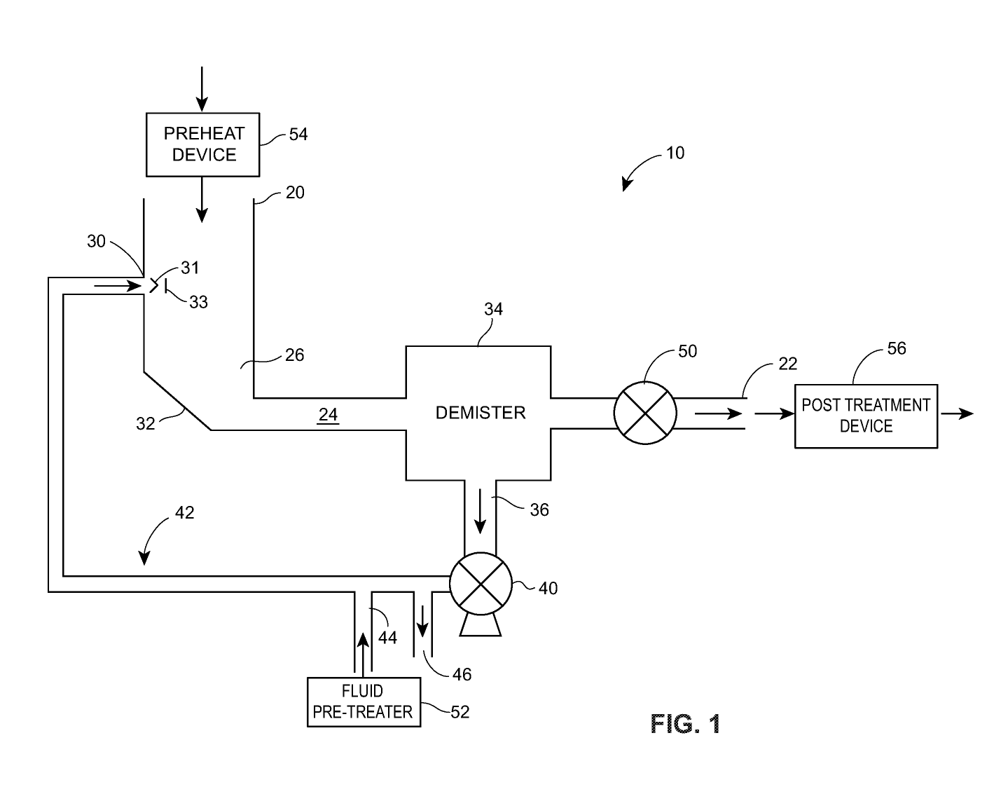

FIG. 1 depicts a generalized schematic diagram of a liquid concentrator 10 that includes a gas inlet 20 (e.g., a heated gas, such as from an air quality control system (AQCS) process), a gas exit 22 (e.g., a cooled gas, such as for return to the AQCS process at a downstream location, delivery to another process, or discharge to the environment), and a flow corridor 24 connecting the gas inlet 20 to the gas exit 22. The flow corridor 24 includes a narrowed portion 26 that accelerates the flow of gas through the flow corridor 24 creating turbulent flow within the flow corridor 24 at or near this location. The narrowed portion 26 in this embodiment may be formed by a venturi device. A liquid inlet 30 injects a liquid to be concentrated (via evaporation) (e.g., a wastewater stream including selenium and/or other waste metals, such as wastewater or purge water from a flue gas desulfurization (FGD) process in the AQCS process) into a liquid concentration chamber in the flow corridor 24 at a point upstream of the narrowed portion 26, and the injected liquid joins with the gas flow in the flow corridor 24. The liquid inlet 30 may include one or more replaceable nozzles 31 for spraying the liquid into the flow corridor 24. The inlet 30, whether or not equipped with a nozzle 31, may introduce the liquid in any direction from perpendicular to parallel to the gas flow as the gas moves through the flow corridor 24. A baffle 33 may also be located near the liquid inlet 30 such that liquid introduced from the liquid inlet 30 impinges on the baffle and disperses into the flow corridor in small droplets.

As the gas and liquid flow through the narrowed portion 26, the venturi principle creates an accelerated and turbulent flow that thoroughly mixes the gas and liquid in the flow corridor 24 at and after the location of the inlet 30. This acceleration through the narrowed portion 26 creates shearing forces between the gas flow and the liquid droplets, and between the liquid droplets and the walls of the narrowed portion 26, resulting in the formation of very fine liquid droplets entrained in the gas, thus increasing the interfacial surface area between the liquid droplets and the gas and effecting rapid mass and heat transfer between the gas and the liquid droplets. The liquid exits the narrowed portion 26 as very fine droplets regardless of the geometric shape of the liquid flowing into the narrowed portion 26 (e.g., the liquid may flow into the narrowed portion 26 as a sheet of liquid). As a result of the turbulent mixing and shearing forces, a portion of the liquid rapidly vaporizes and becomes part of the gas stream. As the gas-liquid mixture moves through the narrowed portion 26, the direction and/or velocity of the gas/liquid mixture may be changed by an adjustable flow restriction, such as a venturi plate 32, which is generally used to create a large pressure difference in the flow corridor 24 upstream and downstream of the venturi plate 32. The venturi plate 32 may be adjustable to control the size and/or shape of the narrowed portion 26 and may be manufactured from a corrosion resistant material including a high alloy metal such as those manufactured under the trade names of HASTELLOY, INCONEL, and MONEL.

After leaving the narrowed portion 26, the gas-liquid mixture passes through a demister 34 (also referred to as fluid scrubbers or entrainment separators) coupled to the gas exit 22. The demister 34 removes entrained liquid droplets from the gas stream. The demister 34 includes a gas-flow passage. The removed liquid collects in a liquid collector or sump 36 mounted beneath the gas-flow passage, the sump 36 may also include a reservoir for holding the removed liquid. A pump 40 fluidly coupled to the sump 36 and/or reservoir moves a portion of the liquid through a re-circulating circuit 42 back to the liquid inlet 30 and/or flow corridor 24. In this manner, the liquid may be reduced through evaporation to a desired concentration. Fresh or new liquid to be concentrated is input to the re-circulating circuit 42 through a liquid inlet 44. This new liquid may instead be injected directly into the flow corridor 24 upstream of the venturi plate 32. The rate of fresh liquid input into the re-circulating circuit 42 may be equal to the rate of evaporation of the liquid as the gas-liquid mixture flows through the flow corridor 24 plus the rate of liquid extracted through a concentrated fluid extraction port 46 located in or near the reservoir in the sump 40. The concentrated fluid extracted though port 46 (e.g., a concentrated wastewater stream including concentrated selenium, other waste metals, and/or a high solids content, such as in the form of a brine slurry) can be fed to one or more downstream unit operations (e.g., solid/liquid separation, further processing in a stabilization/solidification (S/S) process, etc.). The ratio of re-circulated liquid to fresh liquid may generally be in the range of approximately 1:1 to approximately 100:1, and is usually in the range of approximately 5:1 to approximately 25:1. For example, if the re-circulating circuit 42 circulates fluid at approximately 10 gal/min, fresh or new liquid may be introduced at a rate of approximately 1 gal/min (i.e., a 10:1 ratio). A portion of the liquid may be drawn off through the extraction port 46 when the liquid in the re-circulating circuit 42 reaches a desired concentration. The re-circulating circuit 42 adds stability to the evaporation process ensuring that enough moisture is always present in the flow corridor 24 to prevent the liquid from being completely evaporated and/or preventing the formation of dry particulate.

After passing through the demister 34 the gas stream passes through an induction fan 50 that draws the gas through the flow corridor 24 and demister gas-flow corridor under negative pressure. Of course, the concentrator 10 could operate under positive pressure produced by a blower (not shown) prior to the liquid inlet 30. Finally, the gas is vented to the atmosphere or directed for further processing such as for return to the AQCS process or as collection of clean water by means of condensation through the gas exit 22.

The concentrator 10 may include a pre-treatment system 52 for treating the liquid to be concentrated, which may be a wastewater feed. For example, an air stripper may be used as a pre-treatment system 52 to remove substances that may produce foul odors or be regulated as air pollutants. In this case, the air stripper may be any conventional type of air stripper or may be a further concentrator of the type described herein, which may be used in series as the air stripper. The pre-treatment system 52 may, if desired, heat the liquid to be concentrated using any desired heating technique. Additionally, the gas and/or wastewater feed circulating through the concentrator 10 may be pre-heated in a pre-heater 54. Pre-heating may be used to enhance the rate of evaporation and thus the rate of concentration of the liquid. The gas and/or wastewater feed may be pre-heated through combustion of renewable fuels such as wood chips, bio-gas, methane, or any other type of renewable fuel or any combination of renewable fuels, fossil fuels and waste heat. Furthermore, the gas and/or wastewater may be pre-heated through the use of waste heat generated in a landfill flare or stack. Also, waste heat from an engine, such as an internal combustion engine, or a gas turbine, may be used to pre-heat the gas and/or wastewater feed. Still further, natural gas may be used as a source of waste heat, the natural gas may be supplied directly from a natural gas well head in an unrefined condition either immediately after completion of the natural gas well before the gas flow has stabilized or after the gas flow has stabilized in a more steady state natural gas well. Optionally, the natural gas may be refined before being combusted in the flare. Additionally, the gas streams ejected from the gas exit 22 of the concentrator 10 may be transferred into a flare or other post treatment device 56 which treats the gas before releasing the gas to the atmosphere.

### Concentrator Apparatus

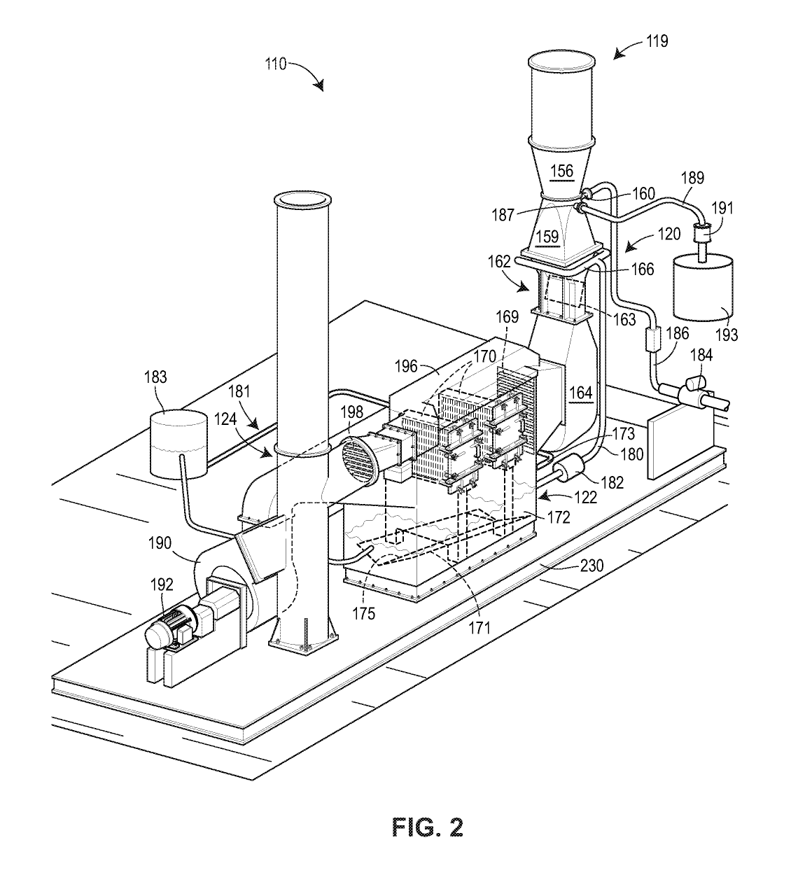

FIG. 2 illustrates one particular embodiment of a (compact) liquid concentrator 110, which can be connected to a source of waste heat in the form of a power plant flue gas exhaust stack. Generally speaking, the compact liquid concentrator 110 of FIG. 2 operates to concentrate wastewater, such as flue gas desulfurization (FGD) purge water from an air quality control system (AQCS) process, using exhaust or waste heat created within a power plant and being treated in the AQCS process. Typically, the heated gas exiting from the exhaust stack and being treated in the AQCS process ranges from about 300 or 400 to 500, 600, or 700 degrees Fahrenheit, although higher temperatures (e.g., whether from the AQCS process or another hot stream/source) are possible, such as up to 800, 1000, 1200,1500, or 1800 degrees Fahrenheit.

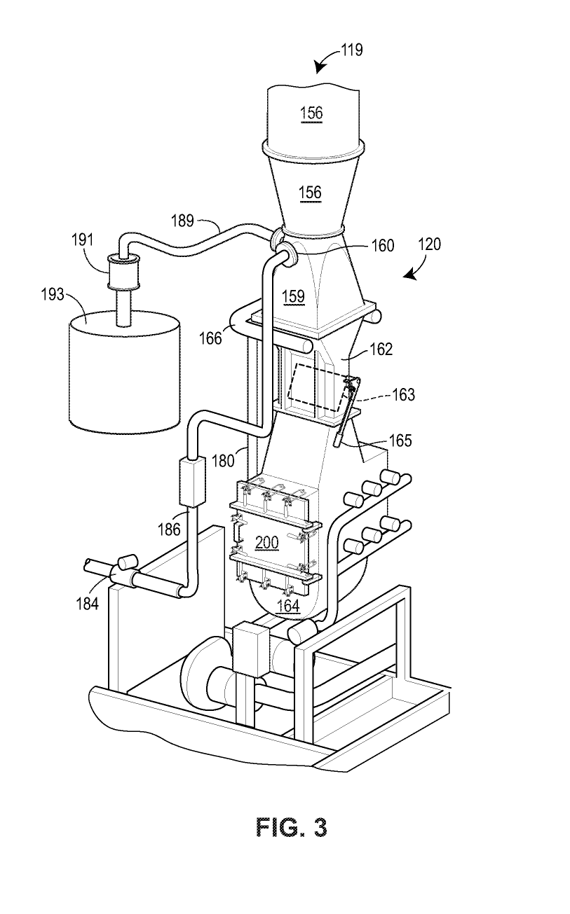

As illustrated in FIG. 2, the compact liquid concentrator 110 generally includes an inlet assembly 119, a concentrator assembly 120 (shown in more detail in FIG. 3), a fluid scrubber 122, and an outlet (or exhaust) section 124. In some embodiments, the inlet assembly 119 provides an interface to the AQCS process, for example a location where a hot side stream pulled from the AQCS process (e.g., such as at one or more locations upstream of the FGD unit operation) is fed to the concentrator 110 as a heated gas to provide thermal energy for wastewater concentration. For example, the concentrator 110/inlet assembly 119 can be interfaced with a flue gas stack of the AQCS process via ductwork and a butterfly control valve (or similar; not shown) that isolates the concentrator 110 when closed and allows for hot flue gas to be drawn in when open. Similarly, a bypass valve (not shown) can be included to operate in the opposite fashion. When the concentrator 110 shuts down, the bypass valve opens to equilibrate the concentrator 110 to atmosphere conditions and help purge the concentrator 110 of any remnant flue gases.

The liquid concentrator assembly 120 includes a lead-in section 156 having a reduced cross-section at the top end thereof which mates to the bottom of the piping section of the inlet assembly 119 (e.g., delivering a hot gas such as a hot flue gas from the AQCS process) to a quencher 159 of the concentrator assembly 120. The concentrator assembly 120 also includes a first fluid inlet 160, which injects new or untreated liquid to be concentrated, such as flue gas desulfurization water from the AQCS process, into the interior of the quencher 159. While not shown in FIG. 2, the inlet 160 may include a coarse sprayer with a large nozzle for spraying the untreated liquid into the quencher 159. Because the liquid being sprayed into the quencher 159 at this point in the system is not yet concentrated, and thus has large amount of water therein, and because the sprayer is a coarse sprayer, the sprayer nozzle is not subject to fouling or being clogged by the small particles within the liquid. The quencher 159 operates to quickly reduce the temperature of the gas stream (e.g., from about 300 or 400 to 500, 600, 700, or 900 degrees Fahrenheit to less than 200 degrees Fahrenheit) while performing a high degree of evaporation on the liquid injected at the inlet 160. If desired, but not specifically shown in FIG. 2, a temperature sensor may be located at or near the exit of the inlet assembly 119 or in the quencher 159 and may be used to control the position of an ambient air valve (not shown) in the inlet assembly 119 to thereby control the temperature of the gas present at the inlet of the concentrator assembly 120.

As shown in FIGS. 2 and 3, the quencher 159 is connected to a liquid injection chamber which is connected to narrowed portion or venturi section 162 which has a narrowed cross section with respect to the quencher 159 and which has a venturi plate 163 (shown in dotted line) disposed therein. The venturi plate 163 creates a narrow passage through the venturi section 162, which creates a large pressure drop between the entrance and the exit of the venturi section 162. This large pressure drop causes turbulent gas flow and shearing forces within the quencher 159 and the top or entrance of the venturi section 162, and causes a high rate of gas flow out of the venturi section 162, both of which lead to thorough mixing of the gas and liquid in the venturi section 162. The position of the venturi plate 163 may be controlled with a manual control rod 165 (shown in FIG. 3) connected to the pivot point of the plate 163, or via an automatic positioner that may be driven by an electric motor or pneumatic cylinder (not shown in FIG. 3).

A re-circulating pipe 166 extends around opposite sides of the entrance of the venturi section 162 and operates to inject partially concentrated (i.e., re-circulated) liquid into the venturi section 162 to be further concentrated and/or to prevent the formation of dry particulate within the concentrator assembly 120 through multiple fluid entrances located on one or more sides of the flow corridor. While not explicitly shown in FIGS. 1 and 2, a number of pipes, such as three pipes of, for example, ½ inch diameter, may extend from each of the opposites legs of the pipe 166 partially surrounding the venturi section 162, and through the walls and into the interior of the venturi section 162. Because the liquid being ejected into the concentrator 110 at this point is re-circulated liquid, and is thus either partially concentrated or being maintained at a particular equilibrium concentration and more prone to plug a spray nozzle than the less concentrated liquid injected at the inlet 160, this liquid may be directly injected without a sprayer so as to prevent clogging. However, if desired, a baffle in the form of a flat plate may be disposed in front of each of the openings of the ½ diameter pipes to cause the liquid being injected at this point in the system to hit the baffle and disperse into the concentrator assembly 120 as smaller droplets. In any event, the configuration of this re-circulating system distributes or disperses the re-circulating liquid better within the gas stream flowing through the concentrator assembly 120.

The combined hot gas and liquid flows in a turbulent manner through the venturi section 162. As noted above, the venturi section 162, which has a moveable venturi plate 163 disposed across the width of the concentrator assembly 120, causes turbulent flow and complete mixture of the liquid and gas, causing rapid evaporation of the discontinuous liquid phase into the continuous gas phase. Because the mixing action caused by the venturi section 162 provides a high degree of evaporation, the gas cools substantially in the concentrator assembly 120, and exits the venturi section 162 into a flooded elbow 164 at high rates of speed. In fact, the temperature of the gas-liquid mixture at this point may be about 160 degrees Fahrenheit.

As is typical of flooded elbows, a weir arrangement (not shown) within the bottom of the flooded elbow 164 maintains a constant level of partially or fully concentrated re-circulated liquid disposed therein. Droplets of re-circulated liquid that are entrained in the gas phase as the gas-liquid mixture exits the venturi section 162 at high rates of speed are thrown outward onto the surface of the re-circulated liquid held within the bottom of the flooded elbow 164 by centrifugal force generated when the gas-liquid mixture is forced to turn 90 degrees to flow into the fluid scrubber 122. Significant numbers of liquid droplets entrained within the gas phase that impinge on the surface of the re-circulated liquid held in the bottom of the flooded elbow 164 coalesce and join with the re-circulated liquid thereby increasing the volume of re-circulated liquid in the bottom of the flooded elbow 164 causing an equal amount of the re-circulated liquid to overflow the weir arrangement and flow by gravity into the sump 172 at the bottom of the fluid scrubber 122. Thus, interaction of the gas-liquid stream with the liquid within the flooded elbow 164 removes liquid droplets from the gas-liquid stream, and also prevents suspended particles within the gas-liquid stream from hitting the bottom of the flooded elbow 164 at high velocities, thereby preventing erosion of the metal that forms the portions of side walls located beneath the level of the weir arrangement and the bottom of the flooded elbow 164.

After leaving the flooded elbow 164, the gas-liquid stream in which evaporated liquid and some liquid and other particles still exist, flows through the fluid scrubber 122 which is, in this case, a cross-flow fluid scrubber. The fluid scrubber 122 includes various screens or filters which serve to remove entrained liquids and other particles from the gas-liquid stream. In one particular example, the cross flow scrubber 122 may include an initial coarse impingement baffle 169 at the input thereof, which is designed to remove liquid droplets in the range of 50 to 100 microns in size or higher. Thereafter, two removable filters in the form of chevrons 170 are disposed across the fluid path through the fluid scrubber 122, and the chevrons 170 may be progressively sized or configured to remove liquid droplets of smaller and smaller sizes, such as 20-30 microns and less than 10 microns. Of course, more or fewer filters or chevrons could be used.

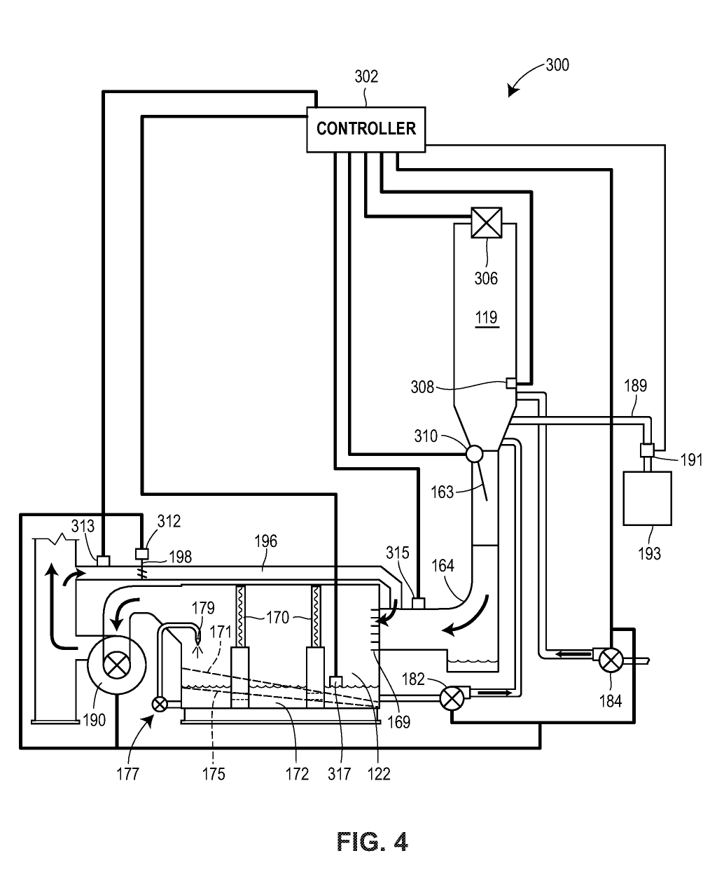

As is typical in cross flow scrubbers, liquid captured by the filters 169 and 170 and the overflow weir arrangement within the bottom of the flooded elbow 164 drain by gravity into a reservoir or sump 172 located at the bottom of the fluid scrubber 122. The sump 172, which may hold, for example approximately 200 gallons of liquid, thereby collects concentrated fluid containing dissolved and suspended solids removed from the gas-liquid stream and operates as a reservoir for a source of re-circulating concentrated liquid back to the concentrator assembly 120 to be further treated and/or to prevent the formation of dry particulate within the concentrator assembly 120. In one embodiment, the sump 172 may include a sloped V-shaped bottom 171 having a V-shaped groove 175 extending from the back of the fluid scrubber 122 (furthest away from the flooded elbow 164) to the front of the fluid scrubber 122 (closest to the flooded elbow 164), wherein the V-shaped groove 175 is sloped such that the bottom of the V-shaped groove 175 is lower at the end of the fluid scrubber 122 nearest the flooded elbow 164 than at an end farther away from the flooded elbow 164. In other words, the V-shaped bottom 171 may be sloped with the lowest point of the V-shaped bottom 171 proximate the exit port 173 and/or the pump 182. Additionally, a washing circuit 177 (FIG. 4) may pump concentrated fluid from the sump 172 to a sprayer 179 within the cross flow scrubber 122, the sprayer 179 being aimed to spray liquid at the V-shaped bottom 171. Alternatively, the sprayer 179 may spray un-concentrated liquid or clean water at the V-shaped bottom 171. The sprayer 179 may periodically or constantly spray liquid onto the surface of the V-shaped bottom 171 to wash solids and prevent solid buildup on the V-shaped bottom 171 or at the exit port 173 and/or the pump 182. As a result of this V-shaped sloped bottom 171 and washing circuit 177, liquid collecting in the sump 172 is continuously agitated and renewed, thereby maintaining a relatively constant consistency and maintaining solids in suspension. If desired, the spraying circuit 177 may be a separate circuit using a separate pump with, for example, an inlet inside of the sump 172, or may use a pump 182 associated with a concentrated liquid re-circulating circuit described below to spray concentrated fluid from the sump 172 onto the V-shaped bottom 171.

As illustrated in FIG. 2, a return line 180, as well as a pump 182, operate to re-circulate fluid removed from the gas-liquid stream from the sump 172 back to the concentrator 120 and thereby complete a fluid or liquid re-circulating circuit. Likewise, a pump 184 may be provided within an input line 186 to pump new or untreated liquid, such as landfill leachate, FGD purge water, or otherwise, to the input 160 of the concentrator assembly 120. Also, one or more sprayers 185 may be disposed inside the fluid scrubber 122 adjacent the chevrons 170 and may be operated periodically to spray clean water or a portion of the wastewater feed on the chevrons 170 to keep them clean.

Concentrated liquid also may be removed from the bottom of the fluid scrubber 122 via the exit port 173 and may be further processed or disposed of in any suitable manner in a secondary re-circulating circuit 181. In particular, the concentrated liquid removed by the exit port 173 contains a certain amount of suspended solids, which preferably may be separated from the liquid portion of the concentrated liquid and removed from the system using the secondary re-circulating circuit 181. For example, concentrated liquid removed from the exit port 173 may be transported through the secondary re-circulating circuit 181 to one or more solid/liquid separating devices 183, such as settling tanks, vibrating screens, rotary vacuum filters, horizontal belt vacuum filters, belt presses, filter presses, and/or hydro-cyclones. After the suspended solids and liquid portion of the concentrated wastewater are separated by the solid/liquid separating device 183, the liquid portion of the concentrated wastewater with suspended particles substantially removed may be returned to the sump 172 for further processing in the first or primary re-circulating circuit connected to the concentrator.

The gas, which flows through and out of the fluid scrubber 122 with the liquid and suspended solids removed therefrom, exits out of piping or ductwork at the back of the fluid scrubber 122 (downstream of the chevrons 170) and flows through an induced draft fan 190 of the outlet assembly 124, from where it can be recycled to the AQCS process (e.g., at a location upstream of the FGD process), recycled to a different process, or exhausted to the atmosphere in the form of the cooled hot inlet gas mixed with the evaporated water vapor. Of course, an induced draft fan motor 192 is connected to and operates the fan 190 to create negative pressure within the fluid scrubber 122 so as to ultimately draw gas through the inlet assembly 119 and the concentrator assembly 120. The induced draft fan 190 needs only to provide a slight negative pressure within the fluid scrubber 122 to assure proper operation of the concentrator 110.

While the speed of the induced draft fan 190 can be varied by a device such as a variable frequency drive operated to create varying levels of negative pressure within the fluid scrubber 122 and thus can usually be operated within a range of gas flow capacity to assure complete gas flow through the inlet assembly 119. If the gas flowing in through the inlet assembly 119 is not of sufficient quantity, the operation of the induced draft fan 190 cannot necessarily be adjusted to assure a proper pressure drop across the fluid scrubber 122 itself. That is, to operate efficiently and properly, the gas flowing through the fluid scrubber 122 must be at a sufficient (minimal) flow rate at the input of the fluid scrubber 122. Typically this requirement is controlled by keeping at least a preset minimal pressure drop across the fluid scrubber 122. However, if at least a minimal level of gas is not flowing in through the inlet assembly 119, increasing the speed of the induced draft fan 190 will not be able to create the required pressure drop across the fluid scrubber 122.

To compensate for this situation, the cross flow scrubber 122 may optionally be designed to include a gas re-circulating circuit which can be used to assure that enough gas is present at the input of the fluid scrubber 122 to enable the system to acquire the needed pressure drop across the fluid scrubber 122. In particular, the gas re-circulating circuit includes a gas return line or return duct 196 which connects the high pressure side of the outlet assembly 124 (e.g., downstream of the induced draft fan 190) to the input of the fluid scrubber 122 (e.g., a gas input of the fluid scrubber 122) and a baffle or control mechanism 198 disposed in the return duct 196 which operates to open and close the return duct 196 to thereby fluidly connect the high pressure side of the outlet assembly 124 to the input of the fluid scrubber 122. During operation, when the gas entering into the fluid scrubber 122 is not of sufficient quantity to obtain the minimal required pressure drop across the fluid scrubber 122, the baffle 198 (which may be, for example, a gas valve, a damper such as a louvered damper, etc.) is opened to direct gas from the high pressure side of the outlet assembly 124 (i.e., gas that has traveled through the induced draft fan 190) back to the input of the fluid scrubber 122. This operation thereby provides a sufficient quantity of gas at the input of the fluid scrubber 122 to enable the operation of the induced draft fan 190 to acquire the minimal required pressure drop across the fluid scrubber 122.

The combination of features illustrated in FIGS. 2-4 makes for a compact fluid concentrator 110 that uses exhaust heat, for example in the form of flue gas resulting from the operation of a power plant, which waste heat might otherwise be vented directly to the atmosphere or be used in a lower-value heat recovery/recycle process. Importantly, the concentrator 110 uses only a minimal amount of expensive high temperature resistant material to provide the piping and structural equipment required to accommodate potentially high temperature gases entering the concentrator via the inlet assembly 119. In fact, due to the rapid cooling that takes place in the venturi section 162 of the concentrator assembly 120, the venturi section 162, the flooded elbow 164 and the fluid scrubber 122 are typically cool enough to touch without harm (even when the gases exiting the exhaust stack 130 are at 1800 degrees Fahrenheit). Rapid cooling of the gas-liquid mixture allows the use of generally lower cost materials that are easier to fabricate and that are corrosion resistant. Moreover, parts downstream of the flooded elbow 164, such as the fluid scrubber 122, induced draft fan 190, and exhaust section 124 may be fabricated from materials such as fiberglass.

The fluid concentrator 110 is also a very fast-acting concentrator. Because the concentrator 110 is a direct contact type of concentrator, it is not subject to deposit buildup, clogging and fouling to the same extent as most other concentrators.

Moreover, in some embodiments, due to the compact configuration of the inlet assembly 119, the concentrator assembly 120 and the fluid scrubber 122, parts of the concentrator assembly 120, the fluid scrubber 122, the draft fan 190 and at least a lower portion of the exhaust section 124 can be permanently mounted on (connected to and supported by) a skid or plate 230, as illustrated in FIG. 2. The upper parts of the concentrator assembly 120 and/or the inlet assembly 119 may be removed and stored on the skid or plate 230 for transport, or may be transported in a separate truck. Because of the manner in which the lower portions of the concentrator 110 can be mounted to a skid or plate, the concentrator 110 is easy to move and install. In particular, during set up of the concentrator 110, the skid 230, with the fluid scrubber 122, the flooded elbow 164 and the draft fan 190 mounted thereon, may be offloaded at the site at which the concentrator 110 is to be used by simply offloading the skid 230 onto the ground or other containment area at which the concentrator 110 is to be assembled. Thereafter, the venturi section 162, the quencher 159, and the inlet assembly 119 may be placed on top of and attached to the flooded elbow 164. In other embodiments, the concentrator 110 can be part of a larger scale, permanent installation (e.g., not necessarily mounted on a moveable skid or plate).

Because most of the pumps, fluid lines, sensors and electronic equipment are disposed on or are connected to the fluid concentrator assembly 120, the fluid scrubber 122 or the draft fan assembly 190 (e.g., in a compact, skid-mounted embodiment), setup of the concentrator 110 at a particular site requires only minimal plumbing, mechanical, and electrical work at the site. As a result, the concentrator 110 is relatively easy to install and to set up at (and to disassemble and remove from) a particular site. Moreover, because a majority of the components of the concentrator 110 are permanently mounted to the skid 230, the concentrator 110 can be easily transported on a truck or other delivery vehicle and can be easily dropped off and installed at particular location, such as next to a landfill exhaust stack, at a power plant to concentrate FGD wastewater using heated flue gas from an AQCS process as a heat source.

FIG. 4 illustrates a schematic diagram of a control system 300 that may be used to operate the concentrator 110. As illustrated in FIG. 4, the control system 300 includes a controller 302, which may be a form of digital signal processor type of controller, a programmable logic controller (PLC) which may run, for example, ladder logic based control, or any other type of controller. The controller 302 is, of course, connected to various components within the concentrator 110, for example as described below.

For instance, the controller 302 may be connected to and control the ambient air inlet valve 306 disposed in the inlet assembly 119 of FIG. 2 upstream of the venturi section 162 and may be used to control the pumps 182 and 184 which control the amount of and the ratio of the injection of new liquid to be treated and the re-circulating liquid being treated within the concentrator 110. The controller 302 may be operatively connected to a sump level sensor 317 (e.g., a float sensor, a non-contact sensor such as a radar or sonic unit, or a differential pressure cell). The controller 302 may use a signal from the sump level sensor 317 to control the pumps 182 and 184 to maintain the level of concentrated fluid within the sump 172 at a predetermined or desired level. Also, the controller 302 may be connected to the induced draft fan 190 to control the operation of the fan 190, which may be a single speed fan, a variable speed fan or a continuously controllable speed fan. In one embodiment, the induced draft fan 190 is driven by a variable frequency motor, so that the frequency of the motor is changed to control the speed of the fan. Moreover, the controller 302 may be connected to a temperature sensor 308 disposed at, for example, the inlet of the concentrator assembly 120 or at the inlet of the venturi section 162, and receive a temperature signal generated by the temperature sensor 308. The temperature sensor 308 may alternatively be located downstream of the venturi section 162 or the temperature sensor 308 may include a pressure sensor for generating a pressure signal.

In any event, as illustrated in FIG. 4, the controller 302 may also be connected to a motor 310 which drives or controls the position of the venturi plate 163 within the narrowed portion of the concentrator assembly 120 to control the amount of turbulence caused within the concentrator assembly 120. Still further, the controller 302 may control the operation of the pumps 182 and 184 to control the rate at which (and the ratio at which) the pumps 182 and 184 provide re-circulating liquid and new waste fluid to be treated to the inputs of the quencher 159 and the venturi section 162. In one embodiment, the controller 302 may control the ratio of the re-circulating fluid to new fluid to be about 10:1, so that if the pump 184 is providing 8 gallons per minute of new liquid to the input 160, the re-circulating pump 182 is pumping 80 gallons per minute. Additionally, or alternatively, the controller 302 may control the flow of new liquid to be processed into the concentrator (via the pump 184) by maintaining a constant or predetermined level of concentrated liquid in the sump 172 using, for example, the level sensor 317. Of course, the amount of liquid in the sump 172 will be dependent on the rate of concentration in the concentrator, the rate at which concentrated liquid is pumped from or otherwise exists the sump 172 via the secondary re-circulating circuit and the rate at which liquid from the secondary re-circulating circuit is provided back to the sump 172, as well as the rate at which the pump 182 pumps liquid from the sump 172 for delivery to the concentrator via the primary re-circulating circuit.

Furthermore, as illustrated in the FIG. 4, the controller 302 may be connected to the venturi plate motor 310 or other actuator which moves or actuates the angle at which the venturi plate 163 is disposed within the venturi section 162. Using the motor 310, the controller 302 may change the angle of the venturi plate 163 to alter the gas flow through the concentrator assembly 120, thereby changing the nature of the turbulent flow of the gas through concentrator assembly 120, which may provide for better mixing of the and liquid and gas therein and obtain better or more complete evaporation of the liquid. In this case, the controller 302 may operate the speed of the pumps 182 and 184 in conjunction with the operation of the venturi plate 163 to provide for optimal concentration of the wastewater being treated. Thus, the controller 302 may coordinate the position of the venturi plate 163 with the operation of the exhaust stack cap 134, the position of the ambient air or bleed valve 306, and the speed of the induction fan 190 to maximize wastewater concentration (turbulent mixing) without fully drying the wastewater so as to prevent formation of dry particulates. The controller 302 may use pressure inputs from the pressure sensors to position the venturi plate 163. Of course, the venturi plate 163 may be manually controlled or automatically controlled.

The controller 302 may also be connected to a motor 312 which controls the operation of the damper 198 in the gas re-circulating circuit of the fluid scrubber 122. The controller 302 may cause the motor 312 or other type of actuator to move the damper 198 from a closed position to an open or to a partially open position based on, for example, signals from pressure sensors 313, 315 disposed at the gas entrance and the gas exit of the fluid scrubber 122. The controller 302 may control the damper 198 to force gas from the high pressure side of the exhaust section 124 (downstream of the induced draft fan 190) into the fluid scrubber entrance to maintain a predetermined minimum pressure difference between the two pressure sensors 313, 315. Maintaining this minimum pressure difference assures proper operation of the fluid scrubber 122. Of course, the damper 198 may be manually controlled instead or in addition to being electrically controlled.

The controller 302 may implement one or more on/off control loops used to start up or shut down the concentrator 110. For example, the controller 302 may implement an induced draft fan control loop which starts or stops the induced draft fan 190 based on whether the concentrator 110 is being started or stopped. Moreover, during operation, the controller 302 may implement one or more on-line control loops which may control various elements of the concentrator 110 individually or in conjunction with one another to provide for better or optimal concentration. When implementing these on-line control loops, the controller 302 may control the speed of induced draft fan 190, the position or angle of the venturi plate 163, and/or the position of the ambient air valve 306 to control the fluid flow through the concentrator 110, and/or the temperature of the air at the inlet of the concentrator assembly 120 based on signals from the temperature and pressure sensors. Moreover, the controller 302 may maintain the performance of the concentration process at steady-state conditions by controlling the pumps 184 and 182 which pump new and re-circulating fluid to be concentrated into the concentrator assembly 120. Still further, the controller 302 may implement a pressure control loop to control the position of the damper 198 to assure proper operation of the fluid scrubber 122. Of course, while the controller 302 is illustrated in FIG. 4 as a single controller device that implements these various control loops, the controller 302 could be implemented as multiple different control devices by, for example, using multiple different PLCs.

### Treatment of Metal-Containing Fluids

Embodiments of the devices and processes described above can be readily modified to accommodate the removal of pollutants from the wastewater being concentrated and also from the exhaust gas employed to concentrate that wastewater. Such modifications are contemplated to be particularly advantageous where the pollutants sought to be removed are among those whose emissions are typically regulated by governmental authorities. Examples of such pollutants include selenium (Se) and/or one or more other common waste metals (e.g., heavy metals) such as arsenic (As), barium (Ba), cadmium (Cd), chromium (Cr), lead (Pb), mercury (Hg), and/or silver (Ag) commonly present in the exhaust gas and related wastewater streams from power plants. Described below are modifications that may be made to the embodiments of the devices and processes described above to accommodate removal of such metals, but that description is not intended to be limiting to the removal of only those pollutants.

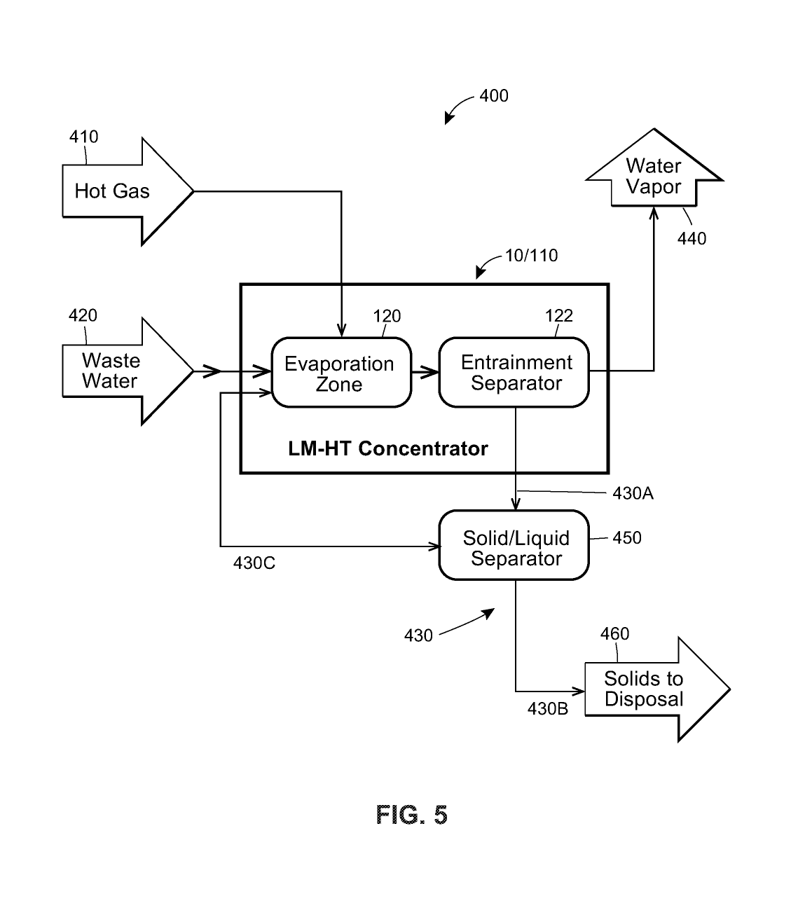

FIG. 5 illustrates a process 400 for concentrating wastewater including one or more metals such as selenium according to the disclosure. In the process 400, a heated gas 410 is combined with a liquid flow of liquid wastewater 420 to form a mixture (e.g., a multiphase mixture) at a first location upstream of a narrowed portion of a mixing corridor, for example after being fed as inlets to a concentrator 10, 110 and mixing in the flow corridor 26/narrowed portion 24 (e.g., in concentration assembly 120). The mixture is drawn through the mixing corridor and the static pressure of the mixture is reduced in the narrowed portion to mix gas and liquid phases of the mixture, thus heating and vaporizing a portion of the liquid in the mixture to yield a partially vaporized mixture. Outlet streams from the concentrator 10, 110 include a concentrated liquid wastewater 430 including the selenium from the liquid wastewater 420 (i.e., at a higher concentration than in stream 420) and a cooled gas 440 including vaporized liquid (e.g., water vapor) from the liquid wastewater 420 as well as components from the original heated gas 410 (e.g., substantially all gaseous components from the original heated gas 410, less some gaseous constituents absorbed into the concentrated liquid wastewater 430 and less any particulate constituents scrubbed into the concentrated liquid wastewater 430). In some embodiments, the cooled gas as originally formed in the concentrator 10, 110 includes entrained liquid droplets comprising selenium (and/or other metals as originally present in the liquid wastewater 420), and at least a portion of the liquid droplets are removed (e.g., in a demister 34 or fluid scrubber 122 portion of the concentrator 10, 110) to form a demisted cooled gas 440 (e.g., which can be recycled to an FGD process as described below). In another embodiment (e.g., using the concentrator 10, 110 or other suitable concentrator apparatus known in the art), a process for concentrating the liquid wastewater 420 can be performed with a heated gas 410 including sulfur dioxide (SO₂) from any suitable source. The heated gas 410 and the liquid wastewater 420 are combined to form a mixture (e.g., multiphase mixture), and at least a portion of the sulfur dioxide from the heated gas 410 is absorbed into the liquid wastewater 420 of the mixture (e.g., via direct contact of the two streams, which can include forming a sulfite or other reaction product of sulfur dioxide and water in the liquid wastewater 420). Heat is transferred directly from the heated gas 410 to the liquid wastewater 420 of the mixture, and the oxidation state of the selenium in the liquid wastewater 420 is chemically reduced (e.g., with the absorbed sulfur dioxide and/or reaction product thereof). This heats and vaporizes a portion of the liquid in the mixture to yield a partially vaporized mixture including a concentrated liquid wastewater 430 including selenium from the liquid wastewater 420 (e.g., in a more chemically reduced form relative to the selenium in the liquid wastewater 420), and a cooled gas 440 including vaporized liquid (e.g., water) from the liquid wastewater 420. In yet another embodiment (e.g., using the concentrator 10, 110 or other suitable concentrator apparatus known in the art), a process for concentrating the liquid wastewater 420 can be performed with any suitable heated gas 410. The heated gas 410 and the liquid wastewater 420 are combined to form a mixture (e.g., multiphase mixture). Heat is transferred directly from the heated gas 410 to the liquid wastewater 420 of the mixture, and the oxidation state of the selenium in the liquid wastewater 420 is chemically with a chemical reducing agent. This heats and vaporizes a portion of the liquid in the mixture to yield a partially vaporized mixture including a concentrated liquid wastewater 430 including selenium from the liquid wastewater 420 (e.g., in a more chemically reduced form relative to the selenium in the liquid wastewater 420), and a cooled gas 440 including vaporized liquid (e.g., water) from the liquid wastewater 420. In some refinements, the reducing agent is fed to the mixture separately from the heated gas 410 and the liquid wastewater 420. In other refinements, the heated gas 410 includes a reducing agent and/or a reducing agent precursor (e.g., sulfur dioxide or other SO_{X} sulfur oxide), and at least a portion of the reducing agent and/or a reducing agent precursor is absorbed from the heated gas 410 into the liquid wastewater 420 (e.g., absorbing the reducing agent itself from the heated gas 410, or absorbing the reducing agent precursor which reacts with water and/or other co-reactant in the liquid wastewater 420 to form the reducing agent in situ in a concentrator unit; for example forming a sulfite or other reaction product reducing agent of sulfur dioxide and water in the liquid). As described below in more detail, the liquid wastewater 420 can include flue gas desulfurization (FGD) purge water, such as from an AQCS process 500. Alternatively or additionally, the heated gas 410 can include a side stream withdrawn from the (AQCS) process. In further embodiments, the heated gas 410 can include a heated gas stream from other than an AQCS process (e.g., gas flare exhaust, electrically heated gas from any source).

The concentration of selenium and/or other metals in the liquid wastewater 420 is not particularly limited and can vary substantially depending on the particular wastewater source. In some embodiments, the liquid wastewater 420 has a total selenium (Se) concentration (i.e., all Se oxidation states combined) ranging from 10 ppb to 10000 ppb (e.g., at least 10 ppb, 100 ppb, 200 ppb, or 500 ppb and/or up to 1000 ppb, 2000 ppb, 5000 ppb, or 10000 ppb on a w/v or w/w basis). Other metals such as arsenic (As), barium (Ba), cadmium (Cd), chromium (Cr), lead (Pb), mercury (Hg), and/or silver (Ag) can be present at similar concentrations/ranges as well.

In some embodiments, the concentrated liquid wastewater 430 further includes solid material, including suspended and/or dissolved solids (i.e., total solids when in combination). Total suspended solids (TSS) and total dissolved solids (TDS) can be determined according to ASTM Method D5907-03 (TDS), USEPA Method 160.1 (TDS), USEPA Method 160.2 (TSS), or equivalent, all of which are incorporated herein by reference. The solid material can include metals or metal-containing materials (selenium or otherwise) originally in or precipitated from the liquid wastewater 420. The solid material also can include fly ash or other particulate material original present in the heated gas 410. The solids content (TDS, TSS, or total solids (TDS and TSS)) in the concentrated liquid wastewater 430 can be at least 30 wt. %, 50 wt. %, or 60 wt. % and/or up to 50 wt. %, 65 wt. %, 70 wt. %, 75 wt. % or 80 wt. % (e.g., 30 wt. % to 50 wt. %, 30 wt. % to 80 wt. %, 50 wt. % to 75 wt. %, or 60 wt. % to 75 wt. %), with the remainder being a liquid (aqueous) medium. The particular solids level can be selected and controlled in the concentrator 10, 110 to achieve a desired level of concentration and/or to achieve a balanced water/solids ratio for a subsequent S/S process (described below). As shown in FIG. 5, the process 400 can further include feeding the concentrated liquid wastewater 430A from the concentrator 10, 110 to a solid/liquid separator unit operation 450, thereby forming a concentrated waste stream 430B including selenium (e.g., a brine slurry with selenium and optionally other waste metals) and a dilute liquid waste stream 430C including selenium (e.g., for recycle to the concentrator 10, 110). The solids content (TDS, TSS, or total solids (TDS and TSS)) in the concentrated waste stream 430B is increased relative to that of the concentrated liquid wastewater 430 and can be at least 30 wt. %, 50 wt. %, 60 wt. %, or 70 wt. % and/or up to 50 wt. %, 65 wt. %, 70 wt. %, 75 wt. %, 80 wt. %, 85 wt. %, or 90 wt. % (e.g., 30 wt. % to 50 wt. %, 30 wt. % to 90 wt. %, 50 wt. % to 90 wt. %, 60 wt. % to 80 wt. %, or 60 wt. % to 85 wt. %), with the remainder being a liquid (aqueous) medium. The solid/liquid separator unit operation 450 is not particularly limited, but it can include one or more settling tanks 610, 620 (e.g., more generally one or two or more separators 450 in series in parallel generally) as well as other possible separators such as thickener tanks, centrifugal separators such as hydrocyclones, etc. The concentrated waste stream 430B is then sent for disposal 460, such as via a stabilization/solidification S/S process as described below.

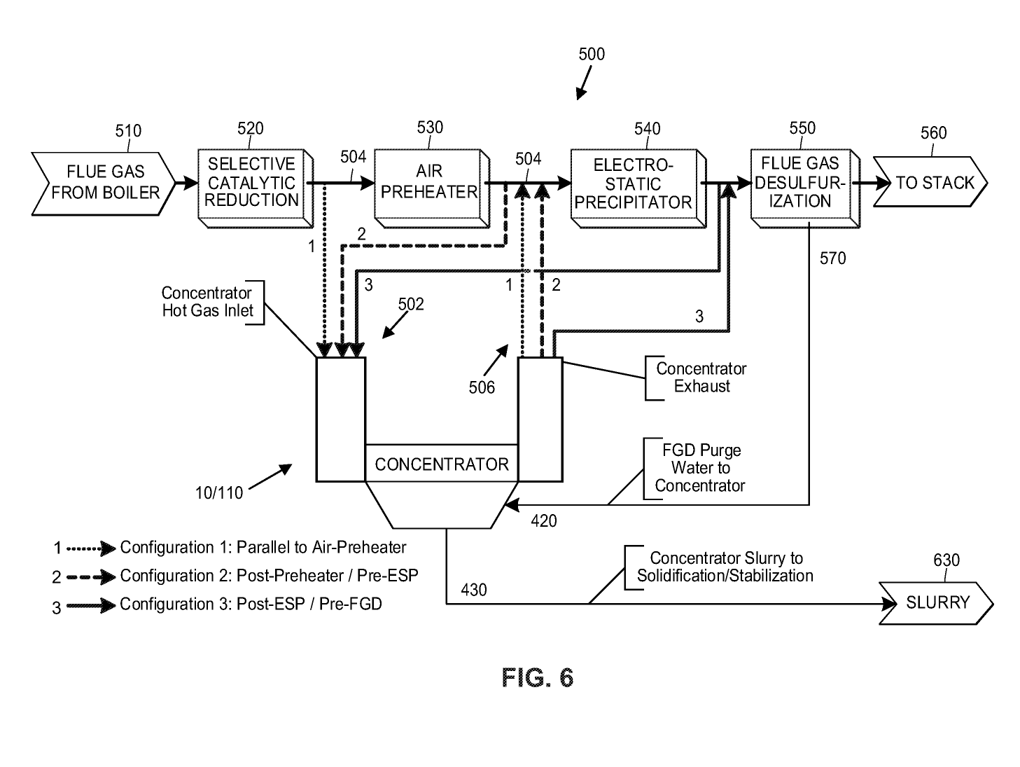

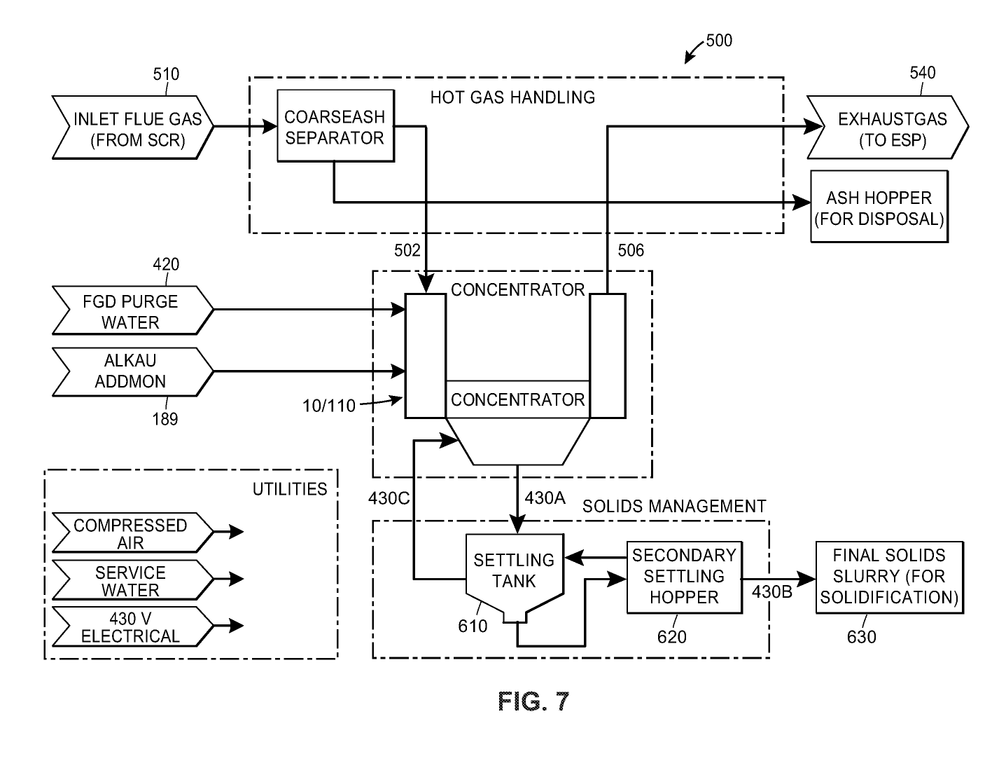

FIG. 6 and FIG. 7 illustrate embodiments in which an AQCS process 500 is interfaced with a concentrator 10, 110 according to the disclosure to use a side stream 502 from the AQCS process 500 as the heated gas 410 used to concentrate FGD purge water 520 (also from the AQCS process 500) as the liquid wastewater 420.

Air quality control systems (AQCS) 500 employed by electric generating units (EGUs or power plants) to process flue gas 510 from a boiler prior to discharge through a stack 560 typically follow a standard process train, though the AQCS process 500 can vary from at a specific EGU installation based on fuel quality (e.g., sulfur, mercury content), applicable environmental regulations, plant age, etc. As particularly illustrated in FIG. 6, conventional unit operations in the AQCS process 500 can include selective catalytic reduction 520, air preheating 530 (e.g., using hot flue gas to heat air to be fed to the EGU boiler, not shown), particulate removal 540 (e.g., to remove fly ash and other particulates from the flue gas, such as via electrostatic precipitation (ESP), a baghouse, or otherwise), and flue gas desulfurization (FGD) 550 (e.g., to remove sulfur dioxide and other sulfur oxides from the flue gas before discharge). Specific to the FGD process 550, particularly a wet FGD system (also known as a scrubber), a liquid FGD wastewater stream 570 is produced as a result of purging the scrubbing liquor while adding make-up water to remove contaminants and maintain an acceptable level of constituents (e.g., keeping chloride levels below a threshold at which they may corrode materials of construction). As such, the FGD wastewater stream 570, which also can contain appreciable concentrations of metal contaminants (e.g., mercury, arsenic, and/or selenium), can be fed to the concentrator 10, 110 as the liquid wastewater 420.

The operating characteristics of the FGD process 550 (scrubber) can have a significant influence on the chemical characteristics of the wastewater stream 570, which is also a function of the quality of the coal used during power production. For example, as selenium speciation can depend on pH and ORP values in the concentrator 10, 110, the pH and ORP operating conditions of the scrubber, and the presence of forced oxidation after the scrubber (e.g., to enhance gypsum production), can significantly impact the oxidation state (e.g., species distribution) of selenium in the wastewater stream 570.

As shown in FIG. 6 and FIG. 7, a side stream 502 can be withdrawn as the heated gas 410 from a main process stream 504 between various unit operations of the AQCS process 500. Suitably, the side stream represents 0.01 vol. % to 50 vol. % (e.g., at least 0.01 vol. %, 0.1 vol. %, 1 vol. %, 2 vol. %, or 5 vol. % and/or up to 1 vol. %, 2 vol. %, 5 vol. %, 10 vol. %, 15 vol. %, 20 vol. %, or 50 vol. %) of the main AQCS process stream 504 from which it is withdrawn, although any desired fraction of the main process stream 504 can be used as the side stream 502. This relatively low fraction of the main stream 504 is often sufficient to provide the desired heat duty in the concentrator 10, 110 while still leaving substantial thermal energy to be recovered from the AQCS process 500 for other uses (e.g., air preheating 530). Suitably, the cooled gas 440 exiting the concentrator 10, 110 can be recycled as a return stream 506 to the AQCS process 500 (e.g., downstream from the point of heated side stream 410/502 withdrawal), for example to remove sulfur dioxide (or other oxides), which were not transferred to the liquid phase in the concentrator 10, 110 and which remain in the cooled 440 upon exit therefrom.

In some embodiments, the side stream 502 is withdrawn from the AQCS process 500 main stream 504 subsequent to one or more unit operations such as the selective catalytic reduction 520, the air preheating 530, and/or the particulate removal process 540. The return stream 506 can be fed to the AQCS process 500 main stream 506 prior to one or more unit operations such as the particulate removal process 540 and/or the FGD process 550 (scrubbing). FIG. 6 illustrates three representative configurations that utilize a hot flue gas side stream 502 for the heated gas 410, although generally any combination of locations for withdrawal and return are possible. In Configuration 1, the side stream 502 is drawn from the air pre-heater (APH) 530 inlet, and the return stream 506 is discharged to the APH 530 outlet. This configuration provides the maximum thermal energy density and temperature (e.g., about 650 degrees F. for the heated gas 410), and it introduces fly ash into the concentrator 10, 110 as it is upstream of the particulate removal process (e.g., ESP) 540. In Configuration 2, the side stream 502 is drawn from the APH 530 outlet and the return stream 506 is discharged to the particulate removal 540 inlet. This configuration utilizes a lower grade flue gas energy (e.g., about 320 degrees F. for the heated gas 410), which has negligible plant heat rate penalty (e.g., commonly viewed as “free energy” in the EGU overall process), and it also contains fly ash. In Configuration 3, the side stream 502 is drawn from the particulate removal 540 outlet and the return stream 506 is discharged to the FGD process 550 inlet. Similar to Configuration 2, this system utilizes a low-grade waste heat (e.g., about 320 degrees F. for the heated gas 410), and does not contain any fly ash or other particulates.

In some embodiments, the heated gas 410 includes sulfur dioxide (SO₂) (e.g., optionally including (minor) amounts of other SO_{X} sulfur oxides), for example when the heated gas 410 is withdrawn from the AQCS process 500 as described above (although generally any sulfur dioxide-containing source can be used). Some sulfur dioxide is absorbed into the liquid wastewater 420 when mixed in the concentrator 10, 110. Commonly, the cooled gas 440 thus includes sulfur dioxide at a lower level relative to the heated gas 410. For example, 5% or 10% to 30% or 50% of sulfur dioxide in the heated gas 410 is transferred to the liquid phase during mixing; conversely, at least 50% or 70% and/or up to 90%, 95%, or 99% of sulfur dioxide in heated gas 410 is also present in cooled gas 440, for example for return to the AQCS system 500 or FGD scrubber 550.

In some embodiments, the heated gas further includes fly ash (FA), for example when the heated gas 410 is withdrawn from the AQCS process 500 as described above (e.g., prior to the particulate removal process 540, although generally any sulfur dioxide-containing source can be used). Generally, most to substantially all of the FA is absorbed into the liquid wastewater 420 when mixed in the concentrator 10, 110. For example, at least 80%, 90%, or 95% and/or up to 90%, 95%, or 99% of FA in the heated gas 410 is transferred to the liquid phase during mixing and only a corresponding residual amount is present in cooled gas 440, for example for return to the AQCS system 500 or FGD scrubber 550. In other embodiments, the heated gas 410 is substantially free from fly ash (FA), for example when the heated gas 410 is withdrawn from the AQCS process 500 subsequent to the particulate removal process 540.

As shown in FIG. 7, the concentrated waste stream 430 or 430B can be treated in a solidification/stabilization (S/S) process 630 to form a solid waste product including selenium and/or any other waste metals being treated in the process. While the illustrated concentrator 10, 110 and solid/liquid separators 610, 620 are suitable apparatus for forming the concentrated waste stream 430, a concentrated waste stream 430 from any desired upstream unit operations (e.g., concentration and/or chemical reduction, or otherwise) can be used, for example where the molar average oxidation state of the selenium in the concentrated waste stream ranges from 0 to 4.5 units (e.g., 0, 1, or 2 to 3, 4, 4.2, or 4.5) and/or the total solids are present in the concentrated waste stream in an amount ranging from 30 wt. % to 90 wt. %. In the S/S process 630, one or more cement-forming additives is combined or mixed with the concentrated waste stream 430 to form a solidification/stabilization (S/S) mixture. The S/S mixture is then cured to form a cementitious solid waste product including immobilized selenium and/or any other waste metals. Curing conditions are not particularly limited and can include simply allowing the S/S mixture to set at ambient conditions in a suitable container for a period of at least about 8 hr to 24 hr up to several days. Suitable cement-forming additives are not particularly limited, and they can include one or more of cement (e.g., portland cement such as type I or II), fly ash (e.g., type C (cementing) fly ash, type F (non-cementing) fly ash), lime, and iron sulfate heptahydrate. Specific cement-forming additives can be selected depending on whether the concentrated waste stream 430 already contains cement-forming constituents (e.g., fly ash captured from the hot stream 410). In some embodiments, the S/S mixture has a concentration of the concentrated waste stream ranging from 50 wt. % to 90 wt. % (e.g., 50 wt. %, 60 wt. %, or 70 wt. % to 70 wt. %, 80 wt. %, or 90 wt. %) and/or a concentration of cement-forming additives ranging from 10 wt. % to 50 wt. % (e.g., 10 wt. %, 20 wt. %, or 25 wt. % to 30 wt. %, 40 wt. %, or 50 wt. %). In some embodiments, the cement-forming additives include cement in the S/S mixture in a concentration ranging from 2 wt. % to 20 wt. % (e.g., 2 wt. %, 5 wt. %, or 10 wt. % to 10 wt. %, 15 wt. %, or 20 wt. %) relative to the S/S mixture. In some embodiments, the cement-forming additives include fly ash in the S/S mixture in a concentration ranging from 5 wt. % to 30 wt. % (e.g., 5 wt. %, 10 wt. %, or 15 wt. % to 20 wt. %, 25 wt. %, or 30 wt. %, which fly ash is added relative to that possible present in the heated gas 410) relative to the S/S mixture.

The chemical reduction of selenium and the concentration of selenium (and/or other waste metals) in the concentrated wastewater 430, and the formation of the solid waste product immobilizes the hazardous selenium and/or other waste metals in a solid matrix that limits, reduces, and/or prevents leaching of the hazardous metals into the environment, for example when the solid waste product is disposed in a landfill or other waste disposal site. This resistance to leaching can be characterized by analyzing the solid waste product according to a toxicity characteristic leaching procedure (TCLP). Suitably, the cementitious solid waste as analyzed by the TCLP analysis has a selenium concentration in the TCLP leachate of less than 1000 ppb (e.g., at least 1 ppb, 10 ppb, 30 ppb, or 100 ppb and/or up to 200 ppb, 400 ppb, 600 ppb, 800 ppb, 900 ppb or 1000 ppb on a w/v basis). In some embodiments, the TCLP selenium concentration in the TCLP leachate is less than 70% of the total selenium concentration in the cementitious solid waste (e.g., at least 0.1%, 1%, 5%, or 10% and/or up to 1%, 2%, 5%, 10%, 20%, 30%, 40%, 50%, 60%, or 70%, with the total concentration being expressed on a consistent basis as the TCLP leachate concentration, such as including the 50:1000 dilution factor for TCLP solid sample relative to TCLP extraction fluid). Alternatively or additionally, the total selenium concentration in the cementitious solid waste (also expressed on a consistent basis as the TCLP leachate concentration) is greater than 1000 ppb (e.g., at least 1000 ppb, 2000 ppb, 5000 ppb, or 10000 ppb and/or up to 2000 ppb, 5000 ppb, 10000 ppb, 20000 ppb, 50000 ppb or 100000 ppb on a w/v basis).

TCLP tests are suitably conducted according to USEPA Method 1311 (or equivalent) to evaluate the leachability of selenium, other metals, or other contaminants from the S/S cementitious solid waste. A representative process is as follows. After curing for 7 days, cementitious solid waste samples are crushed to a small particle size. 50 grams of each crushed solid sample is then added to 1000 grams of TCLP extraction fluid No. 2 in a 1 L high-density polyethylene (HDPE) bottle. The samples are tumbled for 18 hours in a TCLP rotator (e.g., available from Environmental Express, Charleston, SC) to form a TCLP leachate in which all, some, or none of the metal originally present in the cementitious solid waste solid is leached or extracted into the TCLP leachate. The pH and conductivity of the leachate are immediately measured following rotation. The samples are then filtered through 0.7 μm pre-acid washed TCLP syringe filters (also available from Environmental Express) to separate the liquid and solid phases. The filtrate is collected in HDPE containers for metals analysis and glass containers for mercury analysis. The samples are digested according to USEPA Method 3051 (or equivalent), and are analyzed according USEPA Method 6020a (or equivalent) for metals other than mercury and according to USEPA Method 7473 (or equivalent) for mercury. The produced cementitious solid waste samples are also digested per USEPA Method 3051 (or equivalent) and analyzed directly in the same manner for metals (USEPA Method 6020a or 7473) to determine the total metal concentration. The foregoing testing methods are incorporated herein by reference in their entireties. Table 1 below lists Resource Conservation and Recovery Act (RCRA) regulatory maximum limits for various waste metals. Suitably, the TCLP leachate concentration for selenium and/or other waste metals are less than their corresponding TCLP limits (e.g., at least 0.01%, 1%, 5%, or 10% and/or up to 10%, 20%, 30%, 40%, 50%, 60%, 70%, 80%, or 90% of their respective limits).

TABLE 1
TCLP Leachate Limit for Various RCRA Metals

| RCRA Metal | TCLP Limit (μg/L) |
|---|---|
| Arsenic | 5,000 |
| Barium | 100,000 |
| Cadmium | 1,000 |
| Chromium | 5,000 |
| Lead | 5,000 |
| Mercury | 200 |
| Selenium | 1,000 |
| Silver | 5,000 |

In the various process streams and/or the final solid waste product, selenium may be present in several forms (e.g., oxidations states), each with its own physical and chemical properties. Common oxidation states relevant to the disclosed processes include +6 (Se(+6) or Se(VI)), +4 (Se(+4) or Se(IV)), 0 (Se(0)), −2 (Se(−2)), and −4 (Se(−4)). Selenate (SeO₄²⁻, selenium in the +6 oxidation state) is the most oxidized and most soluble form of selenium found in FGD purge waters. Raw FGD purge waters can often have 90-95% or more of its selenium in the selenate form, although in some embodiments, raw FGD purge waters can have less than 90% (or even a minority or no) selenium in the selenate form. From a leaching and stabilization perspective, this is the least desirable form of selenium as it has been found to leach from coal ash piles as well as concentrated brine slurries. Selenite (SeO₃²⁻, selenium in the +4 oxidation state) represents a chemically reduced form of selenate, and generally has low (aqueous) solubility. For this reason, from a leaching and stabilization perspective, this is a desirable form of selenium as it generally can be stabilized. Fly ash often contains on the order of 10 ppm selenium, primarily in the selenite form. Elemental selenium (Se, in the +0 oxidation state) can often show up as an amorphous solid/precipitate (which is red in color), or as a crystalline solid (black in color). This form has very low (aqueous) solubility and thus is also desirable from a stabilization perspective, as it will be less likely to leach from stabilized solid matrix including the selenium. Other forms of selenium compounds also exist, at various stages of oxidation/reduction, including biselenite (HSeO₃⁻¹) selenosulfate (SeSO₃⁻²), selenocyanate (SeCN⁻), hydrogen selenide (H₂Se), and others, but these are often less prevalent in waste streams processed according to the disclosure.

In various embodiments, the selenium in the liquid wastewater 420 is present in one or more oxidation states, for example a combination of one or more of Se (0), Se(IV), Se(VI). Often, the selenium is present in an oxidized form (e.g., Se(IV) and/or Se(VI)), and elemental selenium (Se(0)) can be further present in some cases. In an embodiment, the selenium in the liquid wastewater 420 is present in at least the Se(VI) oxidation state, and Se(VI) is present in at least 50 wt. % (e.g., at least 50 wt. %, 65 wt. %, 80 wt. %, 90 wt. %, or 95 wt. % and/or up to 95 wt. %, 98 wt. %, or 99 wt. %) relative to total selenium in the liquid wastewater 420. In another embodiment, the selenium in the liquid wastewater is present in at least the Se(IV) oxidation state, and Se(IV) is present in at least 50 wt. % (e.g., at least 50 wt. %, 65 wt. %, 80 wt. %, 90 wt. %, or 95 wt. % and/or up to 95 wt. %, 98 wt. %, or 99 wt. %) relative to total selenium in the liquid wastewater. In another embodiment, the selenium in the liquid wastewater is present in both the Se(IV) and Se(VI) oxidation states, and Se(IV) and Se(VI) in combination (e.g., with any given distribution between the two states) are present in at least 50 wt. % (e.g., at least 50 wt. %, 65 wt. %, 80 wt. %, 90 wt. %, or 95 wt. % and/or up to 95 wt. %, 98 wt. %, or 99 wt. %) relative to total selenium in the liquid wastewater. In any of the foregoing embodiments, selenium in the liquid wastewater 420 also can be present in the Se(0) oxidation state, for example up to 50 wt. % (e.g., at least 0.1 wt. %, 1 wt. %, 2 wt. %, 5 wt. %, 10 wt. %, or 20 wt. % and/or up to 5 wt. %, 10 wt. %, 20 wt. %, or 50 wt. %) relative to total selenium in the liquid wastewater 420.

Within the concentrator 10, 110, the mixture of heated gas 410 and liquid wastewater 420 suitably is combined and vaporized under conditions to reduce the oxidation state of the selenium in the liquid wastewater (e.g., with controlled pH or ORP values described below). Thus, selenium is provided in the concentrated liquid wastewater 430 in a more chemically reduced form relative to the selenium in the liquid wastewater 420. Suitably, the molar average oxidation state of the selenium in the concentrated liquid wastewater 430 (or further concentrated waste stream 430/430B) ranges from 0 to 4.5 units (e.g., 0, 1, or 2 to 3, 4, 4.2, or 4.5). This can represent a distribution of primarily Se(0) and Se(IV) species, for example with substantially no Se(VI) or negative selenium oxidation state species present. The molar average oxidation state (Oₐᵥ ) can be determined as follows: Oₐᵥ=Σ(xᵢOᵢ) for all Se species present, where xᵢ is the mole fraction of Se species “i” having oxidation state Oᵢ (e.g., O₁=0, O₂=4, and O₃=6 for a medium containing Se(0), Se (IV), and Se(VI) species). In some embodiments, the molar average oxidation state of the selenium in the concentrated liquid wastewater 430 is lower than the molar average oxidation state of the selenium in the liquid wastewater 420 by 1 to 6 units (e.g., 1, 2, or 3 units to 4, 5, or 6 units). Suitably, the concentrated liquid wastewater 430 is substantially free from selenium species having an oxidation state greater than 4 (e.g., less than 10 mol. %, 5 mol. %, 2 mol. %, 1 mol. %, 0.1 mol. %, or 0.01 mol. % of selenium species having an oxidation state greater than 4, such as Se(VI)), which can be desirable to reduce or eliminate relatively soluble, mobile species in a final solid waste product. Suitably, the concentrated liquid wastewater 430 is substantially free from selenium species having a negative oxidation state (e.g., less than 10 mol. %, 5 mol. %, 2 mol. %, 1 mol. %, 0.1 mol. %, or 0.01 mol. % of selenium species having a negative oxidation state, such as Se(−2) and/or Se(−4) such as in H₂Se or otherwise), for example representing operation of the concentrator 11, 110 under chemical reducing conditions which do no over-reduce the selenium species to negative oxidation states.

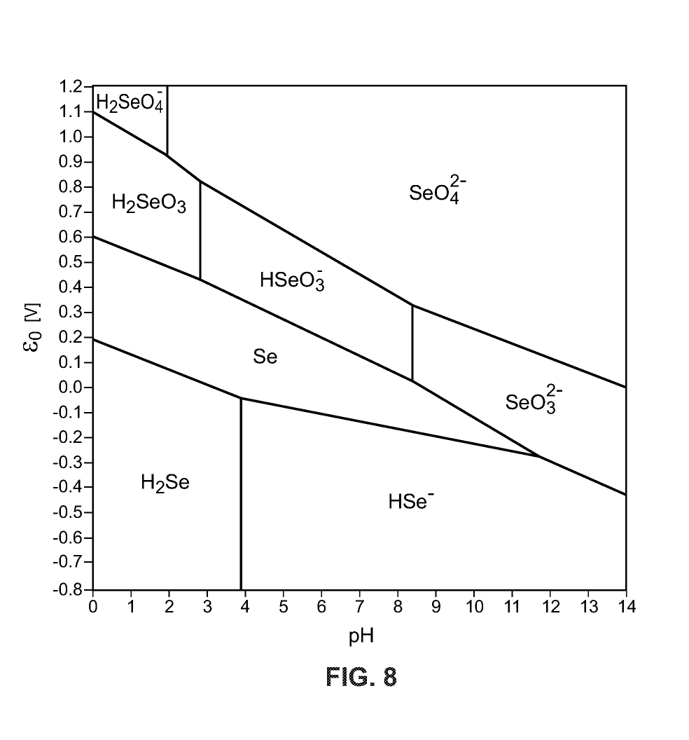

Generally, the favored form of selenium in a solution is a function of both system pH and oxidative-reduction potential (ORP). This illustrated in a representative selenium Pourbaix diagram of FIG. 8, which shows selenium form in water as a function of ORP value (E, measured in volts relative to a standard hydrogen electrode (SHE)) and pH value. FIG. 8 is only representative, and particular selenium species present in the waste fluid streams (e.g., inlet stream, concentrated outlet stream, or otherwise) can vary based on other components of the waste stream as well as ORP and pH values. Conversions between selenium forms and actual species present in a given waste liquid are a function of (often) slow reaction kinetics (e.g., where waste liquids being processed are rarely at chemical equilibrium) and can be heavily dependent on other factors (e.g., temperature, presence of other components, etc.). Thus, the chart of FIG. 8 is primarily illustrative.

In order to facilitate the chemical reduction of highly oxidized selenium (e.g., Se(VI) or Se(IV)) to more favorable chemically reduced forms (e.g., Se(IV) or Se(0)), the concentrating process is suitably performed under reducing conditions such as a selected pH value and/or a selected ORP value. In some embodiments, the reducing conditions can include an acidic pH value (e.g., pH less than 7, for example from 3 or 4 to 4, 5, or 6, such as from 2.5 to 4.5 or 3 to 4) for the concentration process. Alternatively or additionally, the reducing conditions can include a reducing oxidation-reduction potential (ORP) value (e.g., ORP of at least 100 mV, 200 mV, or 300 mV and/or up to 300 mV, 400 mV, or 500 mV relative to a standard hydrogen electrode (SHE)) for the concentration process. For example, one or both of the pH and ORP parameters can be controlled (e.g., by adding a suitable chemical reagent to the concentrator) and/or monitored to maintain a reducing environment to reduce selenium to a distribution of Se(0) and Se(IV) species without over-reducing to negative oxidation states. In some embodiments, a pH-adjusting agent (e.g., an alkaline agent such as sodium hydroxide, lime, other alkali or alkali earth metal hydroxide, other metal hydroxide, or otherwise) can be combined with the mixture of the heated gas 410 and the liquid wastewater 420 in the concentrator 10, 110. For example, when the heated gas 410 includes sulfur dioxide (SO₂) and/or other sulfur oxides, absorption of the sulfur dioxide (or oxides) into the aqueous liquid wastewater 420 medium can create a strongly acidic medium (e.g., pH value of 1 or less). In such case, addition of the alkaline agent partially offsets the acidifying effect to raise the system pH, while still maintaining the system pH in acidic range. In some embodiments, a reducing agent (e.g., a sulfite) or a precursor to a reducing agent (e.g., sulfur dioxide as a precursor to a sulfite when added to water) may be added to the mixture of the heated gas 410 and the liquid wastewater 420 in the concentrator 10, 110 to adjust or control the ORP value.

Referring again to FIG. 2, the concentrator section 120 may include a reagent inlet 187 that is connected to a supply of reagent material 193 (e.g., a pH-adjusting agent such as an alkaline agent) by a supply line 189. A pump 191 may pressurize the supply line 189 with reagent material from the supply of reagent material 193 so that the reagent material is injected into the concentrator section 120 (e.g., proximate the venturi 162) to mix with the exhaust gas from the exhaust stack 130 or generator. In other embodiments, the reagent material may be mixed with the flue gas desulfurization water in the wastewater input line 186 prior to being delivered to the concentrator section 120. Regardless, once the reagent material is delivered to the concentrator section 120, the reagent material rapidly mixes with the exhaust gas in the concentrator section 120 along with the wastewater, as described above. As illustrated in FIG. 4, the controller 302 may be operatively connected to the pump 191 to control the rate at which reagent material is metered into the concentrator section 120. The controller 302 may determine a proper metering rate for the reagent based. Thus, the disclosed concentrator is readily adaptable to variations in exhaust gas components and/or differing mass flow rates of the exhaust gas. As a result, the disclosed concentrator is capable of simultaneously concentrating flue gas desulfurization water and removing pollutants, such as selenium, from the same.

### EXAMPLES

A 1000-gallon per day pilot concentrator 10, 110 as illustrated in FIG. 2 was installed at a coal-fired 950-MW power station, and the efficacy of the adiabatic evaporator/concentrator 10, 110 to concentrate FGD 550 liquid wastewater 420 using flue gas 410 as the sole heat source for the evaporative process was tested during a 15-day demonstration run. Flue gas, being a low-grade and/or waste-heat energy source, may provide a strong economic advantage over other energy sources (e.g., natural gas, propane) for concentration of wastewater. From an air emissions perspective, utilizing the concentrator 10, 110 with flue gas as the heated gas 410 provides a closed-loop vapor stream system integrated with the concentrator 10, 110 upstream of typical traditional emissions controls systems, with no additional air emission points being created. Fly ash contained within the flue gas is partially captured by the concentrator 10, 110 and concentrated along with the FGD 550 liquid wastewater 420, which lends itself to enhancing (and simplifying) downstream solids stabilization processes (fly ash is a typical constituent of solids stabilization processes. Residual, concentrated wastewater 430 from the concentration process can potentially be stabilized and disposed separately from the majority of coal combustion residual materials.

With respect to FIG. 6, the specific embodiment implemented was Configuration 1 (i.e., heated side stream withdrawal from the air preheater 530 inlet and cold return stream to the air preheater 530 outlet). Inlet FGD wastewater 420, concentrated FGD wastewater (brine slurry) 430, circulating fluid within the concentrator 10, 110, and cold exhaust gas/water vapor 440 were sampled and analyzed during the pilot concentrator test. The concentrated FGD wastewater (brine slurry) 430 had the following physical characteristics: (i) TDS of Liquid Phase (mg/kg) =194,620; (ii) TSS of Brine Slurry (mg/kg) =862,700; (iii) Density of Liquid Phase (kg/L) =1.242; and (iv) Density of Brine Slurry (kg/L) =1.652. The brine slurry 430, added coal fly ash (CFA), and portland cement (PC) used in a subsequent solidification/stabilization (S/S) process 630 (see below) were tested for total metal concentrations, which are summarized in Table 2 below. The characteristics of dissolved and suspended constituents were determined for subsequent zero-liquid discharge (ZLD)-type treatment and possibly environmentally acceptable disposal. Throughout the pilot demonstration run, magnesium, sodium and chlorides concentrated by a factor of approximately 15, selenium concentrated up by a factor of approximately 5-10. During the pilot demonstration run, pH in the concentrator 10, 110 was controlled with sodium hydroxide dosing to a targeted pH value of 3.5, and the actual pH value was monitored and ranged between about 2.5 to 4.5. Scrubber pH is typically about 5.5 to 6.0, although it can vary. The ORP value during the demonstration run also were monitored and ranged between about 100 mV to 500 mV (SHE), more generally between about 150 mV to 300 mV or 400 mV (SHE) for most of the run. The low pH operating conditions and low ORP values observed in the concentrator may be conducive to reducing selenate (Se(VI)) to more desirable selenite (Se(IV)) and elemental (Se(0)) forms, thus improving TCLP leachate results.

TABLE 2
Metal Composition of Brine Slurry, CFA, and PC

| | Total Concentration; | Total Concentration; | Total Concentration; |
|---|---|---|---|
| Metal | Brine Slurry (mg/kg) | CFA (mg/kg) | PC (mg/kg) |
| Be | 9.4 | 16.2 | <0.62 |
| B | 1,119.9 | 232.3 | <123.52 |
| Na | 8,992.5 | 2,905.8 | 1,075.2 |
| Mg | 5,536.4 | 4,700.5 | 17,373.7 |
| Al | 59,892.3 | 113,276.1 | 20,106.7 |
| Si | 26,902.9 | 29,482.1 | 5,376.7 |
| K | 9,771.4 | 16,914.3 | 4,100.8 |
| Ca | 45,361.0 | 11,816.5 | 423,941.9 |
| Ti | 3,475.9 | 6,549.1 | 1,283.3 |
| V | 190.3 | 280.8 | 81.8 |
| Cr | 126.1 | 173.2 | 155.1 |
| Mn | 78.0 | 133.2 | 1,190.0 |
| Fe | 25,693.2 | 76,716.7 | 22,505.8 |
| Co | 28.8 | 44.3 | 6.2 |
| Ni | 70.9 | 117.4 | 40.0 |
| Cu | 68.5 | 115.3 | 93.2 |
| Zn | 250.7 | 195.5 | 720.6 |
| As | 65.7 | 69.1 | 7.2 |
| Se | 20.8 | 10.2 | 0.6 |
| Sr | 453.3 | 578.0 | 623.4 |
| Mo | 29.1 | 24.6 | 7.0 |
| Ag | 0.3 | 0.3 | 1.3 |
| Cd | 1.8 | 1.1 | 0.9 |
| Sb | 5.6 | 5.9 | 3.9 |
| Ba | 383.0 | 759.3 | 86.4 |
| Tl | 3.3 | 4.4 | 0.3 |
| Pb | 88.3 | 73.4 | 16.4 |
| U | 13.9 | 13.6 | 2.7 |
| Hg | 2.8 | 0.1 | 0.004 |

The concentrated FGD wastewater (brine slurry) 430, consisting of the concentrated brine and fly ash received in the flue gas, was utilized in a solidification/stabilization (S/S) process 630. The stabilization mixture contained six different mix combinations of coal fly ash (CFA; Class F non-cementing) (i.e., added fly ash in addition to that captured from the flue gas), portland cement (PC; Type I/II), and iron (II) sulfate heptahydrate (FS) as shown in Table 3 below. The concentrated FGD wastewater (brine slurry) 430 for each sample was thoroughly mixed and agitated with the cement-forming additives in Table 3, and then the mixture was allowed to set in a container and cure for up to seven days. The cured, solidified cementitious solid waste samples were analyzed for total metals and TCLP metals, including selenium.

TABLE 3
Solidification/Stabilization (S/S) Mixtures

| Mix No. | Brine Slurry (%) | CFA (%) | PC (%) | FS (%) |
|---|---|---|---|---|
| 1 | 75 | 15 | 10 | 0 |
| 2 | 70 | 20 | 10 | 0 |
| 3 | 75 | 20 | 5 | 0 |
| 4 | 70 | 25 | 5 | 0 |
| 5 | 75 | 8.5 | 10 | 6.5 |
| 6 | 70 | 13.5 | 10 | 6.5 |

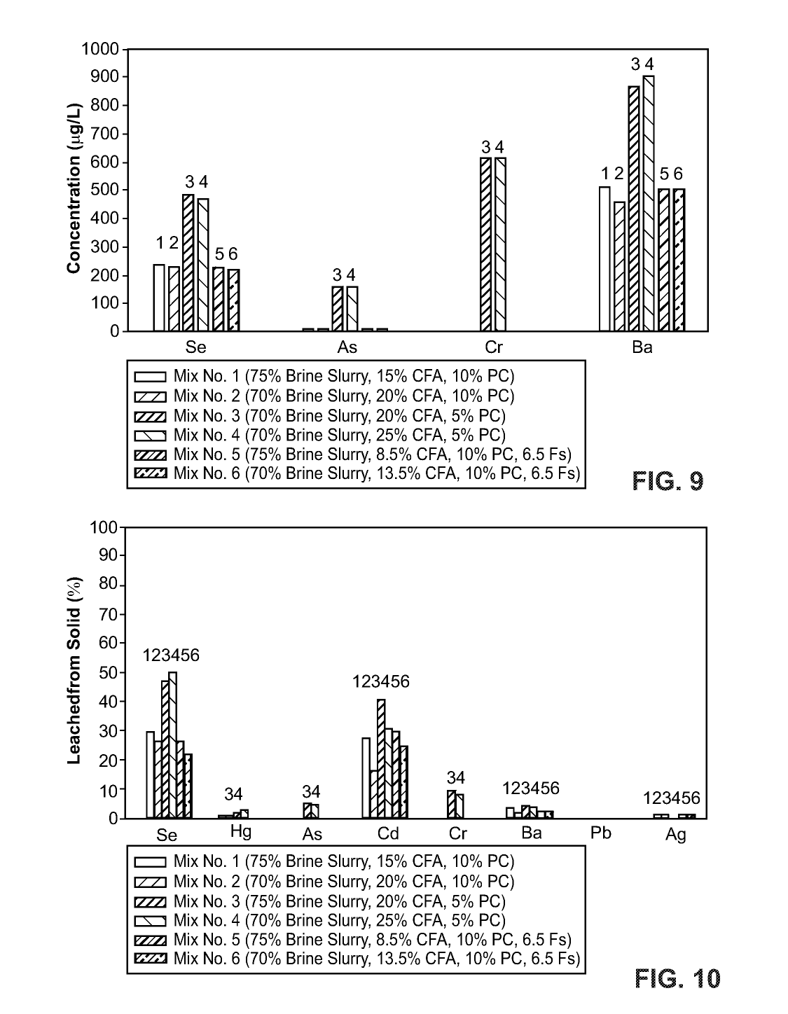

FIG. 9 and FIG. 10 illustrate TCLP metal leachate concentrations for representative metals, including selenium, both in terms of the metal concentration in the TCLP leachate (FIG. 9) and a relative fractional amount of metal leached from the cementitious solid waste into the TCLP leachate (FIG. 10; determined from total metal concentration in the cementitious solid waste and expressed on a consistent basis with the TCLP leachate). In the pilot test, the TCLP leachate concentrations for the RCRA metals, including selenium, were below the TCLP limits in Table 1 above. Of the RCRA metals, selenium came closest to the limits with TCLP concentrations varying from 233 to 486 pg/L. Additionally, mercury was also retained: Mercury TCLP concentrations varied from 1.1 to 3.5 pg/L which was much less than the limit in Table 1 above (result not shown in figures).

Increasing the PC content of the S/S mixture from 5% to 10% enhanced the immobilization of selenium, mercury, arsenic, chromium, copper, and uranium. In fact, selenium leaching decreased from 47-50% to 26-29% when the PC was increased to 10%.

While certain representative embodiments and details have been shown for purposes of illustrating the invention, it will be apparent to those skilled in the art that various changes in the methods and apparatus disclosed herein may be made without departing from the scope of the invention.

1-71. (canceled).

72. A process for concentrating wastewater comprising selenium with a heated gas, the process comprising:
(a) combining the heated gas and a liquid flow of the wastewater to form a mixture thereof; and
(b) directly transferring heat from the heated gas to the liquid of the mixture and chemically reducing the oxidation state of the selenium in the liquid wastewater with a reducing agent, thus heating and vaporizing a portion of the liquid in the mixture to yield a partially vaporized mixture comprising (i) a concentrated liquid wastewater comprising selenium from the liquid wastewater and in a more chemically reduced form relative to the selenium in the liquid wastewater, and (ii) a cooled gas comprising vaporized liquid from the liquid wastewater.

73. The process of claim 72, wherein:
the heated gas comprises a reducing agent or a precursor thereof; and
the process further comprises absorbing at least a portion of the reducing agent or the precursor thereof from the heated gas into the liquid of the mixture.

74. The process of claim 72, further comprising feeding the reducing agent to the mixture separately from the heated gas and the liquid flow of the wastewater.

75. The process of claim 72, wherein the liquid wastewater comprises flue gas desulfurization (FGD) purge water from a flue gas desulfurization (FGD) process.

76. The process of claim 72, wherein the heated gas comprises a side stream withdrawn from a flue gas air quality control system (AQCS) process.

77. The process of claim 76, wherein the side stream represents 0.01 vol. % to 50 vol. % of the main AQCS process stream from which it is withdrawn.

78. The process of claim 76, comprising withdrawing the side stream from an AQCS process stream subsequent to one or more unit operations selected from the group consisting of selective catalytic reduction, air preheating, and particulate removal.

79. The process of claim 76, further comprising feeding the cooled gas as a return stream to the AQCS process.

80. The process of claim 79, comprising feeding the return stream to an AQCS process stream prior to one or more unit operations selected from the group consisting of electrostatic precipitation and flue gas desulfurization (FGD).

81. The process of claim 76, wherein the liquid wastewater comprises flue gas desulfurization (FGD) purge water from the AQCS process.

82. The process of claim 76, wherein the heated gas further comprises a heated gas stream from other than an AQCS process.

83. The process of claim 72, wherein the molar average oxidation state of the selenium in the concentrated liquid wastewater ranges from 0 to 4.5 units.

84. The process of claim 72, wherein the selenium in the liquid wastewater is present in one or more oxidation states selected from the group consisting of Se(IV) and Se(VI).

85. The process of claim 84, wherein the selenium in the liquid wastewater is present in at least the Se(VI) oxidation state, and Se(VI) is present in at least 50 wt. % relative to total selenium in the liquid wastewater.

86. The process of claim 84, wherein the selenium in the liquid wastewater is present in at least the Se(IV) oxidation state, and Se(IV) is present in at least 50 wt. % relative to total selenium in the liquid wastewater.

87. The process of claim 84, wherein the selenium in the liquid wastewater is present in both the Se(IV) and Se(VI) oxidation states, and Se(IV) and Se(VI) in combination are present in at least 50 wt. % relative to total selenium in the liquid wastewater.

88. The process of claim 84, wherein the selenium in the liquid wastewater further is present in the Se(0) oxidation state and in an amount up to 50 wt. % relative to total selenium in the liquid wastewater.

89. The process of claim 72, wherein the molar average oxidation state of the selenium in the concentrated liquid wastewater is lower than the molar average oxidation state of the selenium in the liquid wastewater by 1 to 6 units.

90. The process of claim 72, wherein the concentrated liquid wastewater is substantially free from selenium species having an oxidation state greater than 4.

91. The process of claim 72, wherein the concentrated liquid wastewater is substantially free from selenium species having a negative oxidation state.

92. The process of claim 72, wherein the reducing conditions are selected from the group consisting of an acidic pH value and a reducing oxidation-reduction potential (ORP) value.

93. The process of claim 72, wherein the liquid wastewater has a total selenium concentration ranging from 10 ppb to 10000 ppb.

94. The process of claim 72, wherein the liquid wastewater further comprises one or more metals selected from the group consisting of arsenic (As), barium (Ba), cadmium (Cd), chromium (Cr), lead (Pb), mercury (Hg), and silver (Ag).

95. The process of claim 72, wherein the heated gas comprises sulfur dioxide (SO₂).

96. The process of claim 95, wherein the cooled gas comprises sulfur dioxide at a lower level relative to the heated gas.

97. The process of claim 95, wherein the heated gas further comprises fly ash (FA).

98. The process of claim 95, wherein the heated gas is substantially free from fly ash (FA).

99. The process of claim 72, further comprising combining a pH-adjusting agent with the mixture of the heated gas and the liquid wastewater.

100. The process of claim 99, wherein the pH-adjusting agent comprises an alkaline agent and the heated gas comprises sulfur dioxide (SO₂).

101-121. (canceled).
